(19) United States
(12) Patent Application Publication
(10) Pub. No.: US 2023/0216893 A1
(43) Pub. Date: Jul. 6, 2023

(54) NODE IN WIRELESS COMMUNICATION SYSTEM AND METHOD PERFORMED THEREBY

(71) Applicant: Samsung Electronics Co., Ltd., Suwon-si (KR)

(72) Inventors: Xiaoning MA, Beijing (CN); Lixiang XU, Beijing (CN); Hong WANG, Beijing (CN); Weiwei WANG, Beijing (CN)

(21) Appl. No.: 18/149,833

(22) Filed: Jan. 4, 2023

(30) Foreign Application Priority Data
Jan. 4, 2022 (CN) 202210002280.4

(51) Int. Cl. H04L 65/1016; H04W 76/20; H04W 36/08

(52) U.S. Cl. CPC H04L 65/1016; H04W 76/20; H04W 36/08

(57) ABSTRACT

A method performed by a user equipment (UE) in a wireless communication system is provided. The method includes generating a report, and transmitting the report to an access node in the wireless communication system, wherein the report is generated in or after an Internet Protocol (IP) Multimedia Subsystem (IMS) voice related process of the UE.

### CROSS-REFERENCE TO RELATED APPLICATION(S)

This application is based on and claims under 35 U.S.C. § 119(a) of a Chinese patent application number 202210002280.4, filed on Jan. 4, 2022, in the Chinese Intellectual Property Office, the disclosure of which is incorporated by reference herein in its entirety.

### BACKGROUND

### 1. Field

The disclosure relates to a field of wireless communication. More particularly, the disclosure relates to a node in a wireless communication system and a method performed thereby.

### 2. Background of Related Art

The 5^{th} generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement 6^{th} generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive Multiple-Input Multiple-Output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a communication method in a wireless communication.

According to various embodiments of the disclosure, procedures regarding supporting handover and receiving report can be efficiently enhanced.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes generating a report, and transmitting the report to an access node in the wireless communication system, wherein the report is generated in or after an Internet Protocol (IP) Multimedia Subsystem (IMS) voice related process of the UE.

In accordance with another aspect of the disclosure, a method performed by a first node in a wireless communication system is provided. The method includes obtaining first information from at least one other node in the wireless communication system, which indicates that a problem occurs in or after an Internet Protocol (IP) Multimedia Subsystem (IMS) voice related process of a user equipment (UE), and optimizing IMS voice fallback related parameters in response to obtaining the first information, wherein the first node is an access node, and the at least one other node is a UE or another access node or a core network node in the wireless communication system.

In accordance with another aspect of the disclosure, a method performed by a second node in a wireless communication system is provided. The method includes transmitting first information to a first node, which indicates that a problem occurs in or after an Internet Protocol (IP) Multimedia Subsystem (IMS) voice related process of a user equipment (UE), wherein the first node is an access node in the wireless communication system, and the second node is another access node or a core network node in the wireless communication system.

In accordance with another aspect of the disclosure, a node in a wireless communication system is provided. The node includes a transceiver configured to transmit and receive data, and a processor configured to control the transceiver to perform various methods of the disclosure.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features and advantages of certain embodiments of the disclosure will be more apparent from the following description taken in conjunction with the accompanying drawings, in which:

FIG. 1 is a system architecture of System Architecture Evolution (SAE) according to an embodiment of the disclosure;

FIG. 2 is a system architecture according to an embodiment of the disclosure;

FIG. 3A is a system architecture according to an embodiment of the disclosure;

FIG. 3B illustrates a method performed by a first node in a wireless communication system according to an embodiment of the disclosure;

FIG. 3C illustrates a method performed by a second node in a wireless communication system according to an embodiment of the disclosure;

FIG. 3D illustrates a method performed by a user equipment (UE) in a wireless communication system according to an embodiment of the disclosure;

FIG. 4 is a schematic diagram illustrating a situation where a UE adds Internet Protocol (IP) Multimedia Subsystem (IMS) voice fallback related information in a generated report in a wireless communication system according to an embodiment of the disclosure;

FIG. 5 is a schematic diagram illustrating a situation where a radio connection related failure occurs between a UE and a target cell in an IMS voice fallback handover process and then the UE reconnects to a new cell according to an embodiment of the disclosure;

FIG. 6 is a schematic diagram illustrating a situation where a radio connection related failure occurs between a UE and a redirected cell in an IMS voice fallback redirection process and then the UE reconnects to a new cell according to an embodiment of the disclosure;

FIG. 7A is a schematic diagram illustrating a situation where a UE performs an IMS voice fallback process, switches from a 5G network to a 4^{th} generation (4G) network, and connects to the 5G network again according to an embodiment of the disclosure;

FIG. 7B is a schematic diagram illustrating a situation where a UE performs an IMS voice fallback process, switches from a 5G network to a 4G network, and connects to the 5G network again according to an embodiment of the disclosure;

FIG. 8 is a schematic diagram illustrating another situation where a UE performs an IMS voice fallback process, switches from a 5G network to a 4G network, and connects to the 5G network again according to an embodiment of the disclosure;

FIG. 9 is a schematic diagram illustrating a situation where a UE performs an IMS voice fallback process, switches from a next generation node B (gNB) to a next generation evolved node B (ng-eNB), and connects to a gNB again according to an embodiment of the disclosure;

FIG. 10A is a schematic diagram illustrating a situation where a UE performs an IMS voice fallback process, a gNB decides to redirect the UE to an eNB1, and the UE connects to an eNB2 again according to an embodiment of the disclosure;

FIG. 10B is a schematic diagram illustrating a situation where a UE performs an IMS voice fallback process, a gNB decides to redirect the UE to an eNB1, and the UE connects to an eNB2 again according to an embodiment of the disclosure;

FIG. 11A is a schematic diagram illustrating a situation where a UE performs an IMS voice fallback process, a gNB decides to redirect the UE to a ng-eNB1, and the UE connects to a ng-eNB2 again according to an embodiment of the disclosure;

FIG. 11B is a schematic diagram illustrating a situation where a UE performs an IMS voice fallback process, a gNB decides to redirect the UE to a ng-eNB1, and the UE connects to a ng-eNB2 again according to an embodiment of the disclosure;

FIG. 12 is a schematic diagram illustrating a situation where an access node broadcast whether an IMS voice (IMS voice) capability is supported according to an embodiment of the disclosure;

FIG. 13 is a schematic diagram illustrating a situation where a secondary node (SN) selects a target SN while considering an IMS voice service in an SN change process initiated by the SN according to an embodiment of the disclosure;

FIG. 14 illustrates a block diagram of a structure of a node according to an embodiment of the disclosure;

FIG. 15 is a block diagram illustrating a structure of a UE according to an embodiment of the disclosure;

FIG. 16 is a block diagram illustrating a structure of a base station (BS) according to an embodiment of the disclosure; and

FIG. 17 is a block diagram illustrating a structure of a network entity according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

In a 5G system, a user equipment (UE) is a terminal equipment used to receive data. An access node (also called “access network node”, which may be a gNB or an ng-eNB, etc.) provides the UE with interfaces to access the radio network. An access control and mobility management function entity (AMF) is responsible for managing mobility context and security information of the UE. A user plane function entity (UPF) mainly provides functions of user plane. A session management function entity (SMF) is responsible for session management.

If the UE is connected to a gNB, when configuring an IMS voice service for the UE, the gNB may receive a configuration request from the core network (such as AMF). If the gNB can't support this service, it may reject this configuration request, and then initiate an IP Multimedia Subsystem (IMS) voice fallback process, which may be a handover or redirection process. In the IMS voice fallback process, the UE may connect to an access node (eNB) or an ng-eNB of a 4G system, and then re-configure the IMS voice service.

In the above process, if IMS voice fallback related parameters are set improperly, such as a target cell for handover or configuration information for redirection being not suitable, the UE may encounter a radio connection failure or another similar failure in the IMS voice fallback process, resulting finally in an IMS voice service configuration failure.

In the prior art, when the UE encounters a radio connection failure or another similar failure, a failure report corresponding to the failure will be generated. The failure report does not include IMS voice fallback related information. Even if an access node receives the failure report transmitted by the UE, this access node or another access node can't determine whether the failure is caused by IMS voice fallback, so targeted optimization can't be performed.

In the prior art, the IMS voice fallback related information is not exchanged between access nodes or between an access node and a core network node. Even if an access node receives the failure report transmitted by the UE, this access node or another access node can't determine whether the failure is caused by IMS voice fallback, so targeted optimization can't be performed.

The disclosure provides a self-optimizing and self-configuring method. By this method, required information may be provided to an access node or a core network node, so that it can be determined whether the radio connection failure or another similar failure of the UE is caused by the IMS voice fallback process (for example, since IMS voice fallback related parameters are set improperly), thus IMS voice fallback related parameters can be optimized, network performance can be improved, and possibility of radio connection failure or another similar failure of the UE in the IMS voice fallback process can be reduced.

When the UE transmits the generated report (e.g., a radio connection failure report, e.g., a radio link failure (RLF) report) to an access node, IMS voice fallback related information may be included in the report. The access node or another access node may determine, according to the information carried in the report, that the UE encounters a radio connection related failure, and the failure is caused by IMS voice fallback. Then network parameters can be optimized and similar errors can be reduced.

In the IMS voice fallback process, the access node or the core network node may determine, according to the received IMS voice fallback related information, that the UE may have encountered a radio connection related failure, and the failure is caused by IMS voice fallback. Then network parameters can be optimized and similar errors can be reduced.

Hereinafter, the UE may generate the report in or after the IMS voice related process. The report includes first information. The first information may be related information for the IMS voice related process.

The aforementioned IMS voice related process may be an IMS voice fallback process or an IMS voice service configuration process or an emergency fallback process. For convenience of description, hereinafter, “IMS voice related process” may be referred to as “IMS voice fallback” or “IMS voice fallback process” or “IMS voice fallback related process”. Hereinafter, “IMS voice fallback” or “IMS voice fallback process” or “IMS voice fallback related process” may also be understood as including an IMS voice fallback process or an IMS voice service configuration process or an emergency fallback process.

For convenience of description, hereinafter, “related information for the IMS voice related process” may be referred to as “IMS voice fallback related information”. “IMS voice fallback related information” may also be understood as “related information for the IMS voice related process”.

The related information for the IMS voice related process (hereinafter, also referred to as “IMS voice fallback related information”) includes but is not limited to at least one of the following information:
indication information, indicating that the report generated by the UE (e.g., a radio connection failure report (e.g., a RLF report)) is caused by an IMS voice fallback process or an IMS voice service configuration process or an emergency fallback process, or that the related information for the IMS voice related process (hereinafter, also referred to as “IMS voice fallback related information”) is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN (absolute radio frequency channel number)) and/or a cell identifier used by a target cell;
frequency information (e.g., ARFCN (absolute radio frequency channel number)) and/or a cell identifier used by a cell in which a radio connection related failure occurs;
frequency information (e.g., ARFCN) used by and/or a cell identifier of a reconnected cell;
frequency information (e.g., ARFCN) used by and/or a cell identifier of a cell initiating the IMS voice fallback process;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
service interruption time, for example, a difference between the time when the UE initiates an IMS voice service and the time when the access node transmits an IMS voice fallback indication to the UE, and/or a difference between the time when the access node transmits an IMS voice fallback indication to the UE and the time when establishment of the IMS voice service is completed (for example, establishment of a radio bearer or a QoS flow for transferring data of the IMS voice service is completed), and/or a difference between the time when the UE initiates an IMS voice service and the time when establishment of the IMS voice service is completed;
a report type, indicating a problem that occurs in the IMS voice related process (hereinafter, also referred to as “IMS voice fallback process”), for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

Herein the report may be a Radio Link Failure (RLF) report, or a Connection Establishment Failure (CEF) report, or secondary cell group failure information (SCGFailurelnformation), or a Successful Handover Report (SHR), or a Random Access Report (RA), or master cell group failure information (MCGFailurelnformation), or a new RRC report.

Herein the cell identifier may be at least one of the following information:
Global cell identifier (CGI);
Physical cell ID and ARFCN.

Herein the redirectedCarrierInfo, cellReselectionPriorities and measIdleConfig are defined in relevant communication standards.

The term “include” or “may include” refers to the existence of a corresponding disclosed function, operation or component which can be used in various embodiments of the disclosure and does not limit the existence of one or more additional functions, operations, or components. The terms such as “include” and/or “have” may be construed to denote a certain characteristic, number, step, operation, constituent element, component or a combination thereof, but may not be construed to exclude the possibility of existence of one or more other characteristics, numbers, steps, operations, constituent elements, components or combinations thereof. The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

When describing the embodiments of the disclosure, description related to technical contents well-known in the art but not directly related to the disclosure may be omitted. Such omission of unnecessary description is intended to prevent confusion of the main idea of the disclosure.

Advantages and features of the disclosure and implementations thereof will be apparent by referring to the following embodiments in detail in conjunction with the accompanying drawings. However, the disclosure is not limited to the embodiments set forth below, but may be implemented in various forms. The following embodiments are provided only to fully disclose the disclosure and inform those skilled in the art of the scope of the disclosure, and the disclosure is only defined by the scope of the appended claims. Throughout the specification, the same or similar reference numerals refer to the same or similar elements.

Herein, it should be understood that each block of flowchart illustrations and combinations of blocks in the flowchart illustrations may be implemented by computer program instructions. These computer program instructions may be provided to a processor of a general-purpose computer, a special-purpose computer or other programmable data processing apparatus to produce a machine, such that the instructions executed via the processor of the computer or other programmable data processing apparatus create means for implementing the functions specified in one or more flowchart blocks. These computer program instructions may also be stored in a computer-usable or computer-readable memory, which may instruct a computer or other programmable data processing apparatus to work in a specific way, so that the instructions stored in the computer-usable or computer-readable memory produce an article of manufacture, which includes instruction means that implement the functions specified in one or more flowchart blocks. Computer program instructions may also be loaded on a computer or other programmable data processing apparatus to cause a series of operations to be performed on the computer or other programmable apparatus to produce a computer-implemented process, so that the instructions executed on the computer or other programmable apparatus provide operations for implementing the functions specified in one or more flowchart blocks.

Furthermore, each block of the flowchart may represent a module, segment or portion of code, which includes one or more executable instructions for implementing specified logical function(s). It should also be noted that in some alternative implementations, functions shown in the blocks may occur out of order. For example, depending on the functions involved, two blocks shown in succession may actually be performed substantially at the same time, or the blocks may be performed in a reverse order.

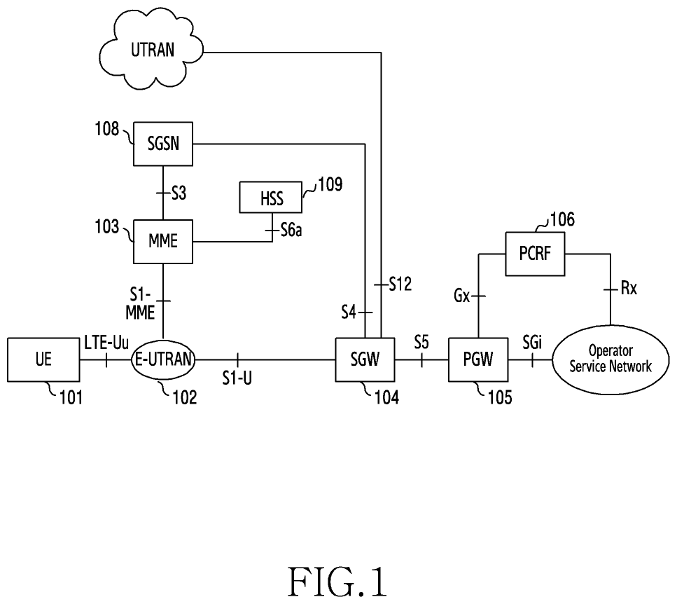

FIGS. 1, 2, 3A, 3B, 3C, 3D, 4, 5, 6, 7A, 7B, 8, 9, 10A, 10B, 11A, 11B, 12, 13, 14, 15, 16, and 17 discussed below and various embodiments for describing the principles of the disclosure in this patent document are only for illustration and should not be interpreted as limiting the scope of the disclosure in any way. Those skilled in the art will understand that the principles of the disclosure can be implemented in any suitably arranged system or device.

FIG. 1 is a system architecture 100 of system architecture evolution (SAE). User equipment (UE) 101 is a terminal device for receiving data according to an embodiment of the disclosure.

An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

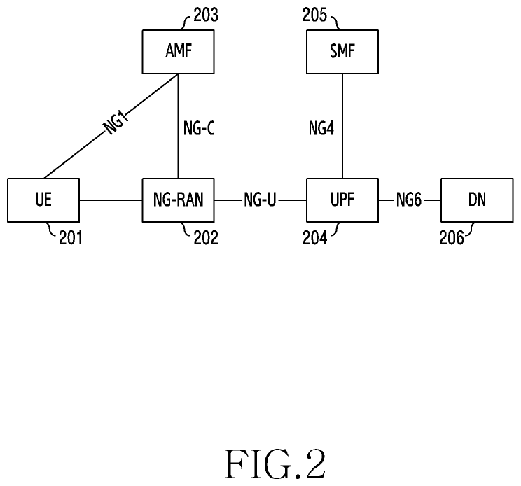

FIG. 2 is a system architecture 200 according to an embodiment of the disclosure. Other embodiments of the system architecture 200 can be used without departing from the scope of the disclosure.

User equipment (UE) 201 is a terminal device for receiving data. A next generation radio access network (NG-RAN) 202 is a radio access network, which includes a base station (a gNB or an eNB connected to the 5G core network 5GC, and the eNB connected to the 5GC is also called ng-eNB) that provides UE with interfaces to access the radio network. An access control and mobility management function (AMF) entity 203 is responsible for managing mobility context and security information of the UE. A user plane function entity (UPF) 204 mainly provides functions of user plane. A session management function (SMF) entity 205 is responsible for session management. A data network (DN) 206 includes, for example, services of operators, access of Internet and services of third parties.

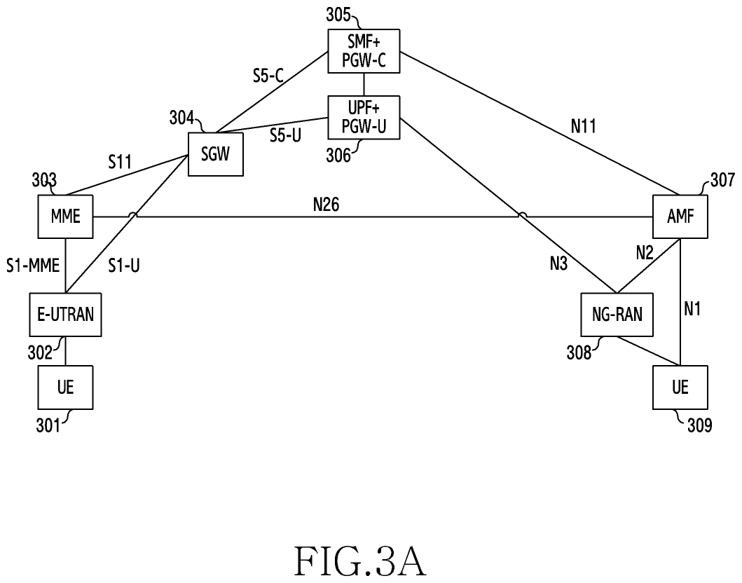

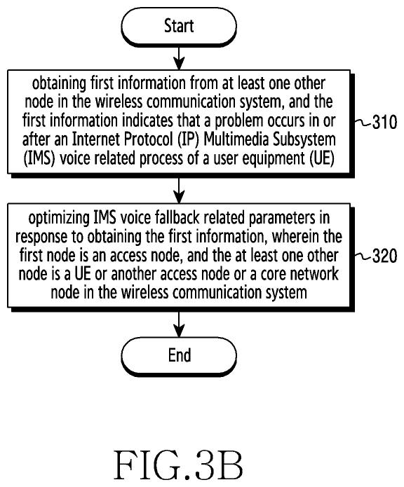

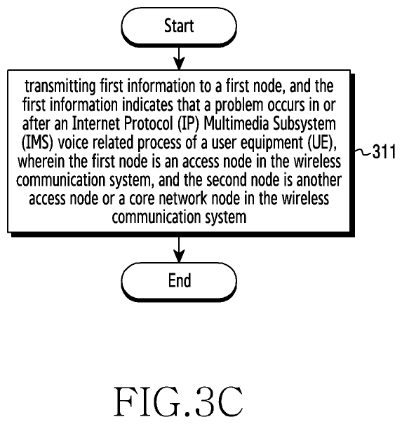

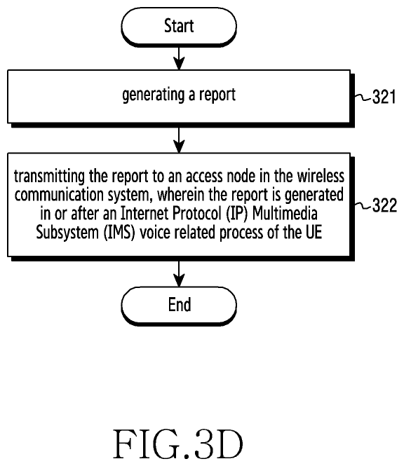

FIG. 3A is a system architecture 300 according to an embodiment of the disclosure. Other embodiments of the system architecture 300 can be used without departing from the scope of the disclosure.

User equipments (UEs) 301 and 309 are terminal devices for receiving data. The evolved universal terrestrial radio access network (E-UTRAN) 302 and the next generation radio access network (NG-RAN) 308 are radio access networks, which include base stations (eNBs, gNBs, or ng-eNBs) that provide the UE with interfaces to access the radio network. The mobility management entity (MME) 303 and the access control and mobility management function entity (AMF) 307 are responsible for managing mobility context and security information of the UE. The session management function entity (SMF+PGW−C) 305, user plane function entity (UPF+PGW−U) 306 and service gateway (SGW) 304 mainly provide session management and user plane functions.

Various embodiments of the disclosure are further described below with reference to the accompanying drawings.

The text and drawings are provided as examples only to help understand the disclosure. They should not be interpreted as limiting the scope of the disclosure in any way. Although certain embodiments and examples have been provided, based on the disclosure herein, it will be apparent to those skilled in the art that changes may be made to the illustrated embodiments and examples without departing from the scope of the disclosure.

The application provides a self-configuring and self-optimizing method. In order to make the purpose, technical solution and advantages of the application clearer, the application will be further explained in detail with reference to the accompanying drawings and embodiments.

FIG. 3B illustrates a method performed by a first node in a wireless communication system according to an embodiment of the disclosure.

Referring to FIG. 3B, at operation 310, the first node may obtain first information from at least one other node in the wireless communication system, and the first information indicates that a problem occurs in or after an Internet Protocol (IP) Multimedia Subsystem (IMS) voice related process of a user equipment (UE). At operation 320, the first node may optimize IMS voice fallback related parameters in response to obtaining the first information. The first node may be an access node. The at least one other node may be a UE or another access node or a core network node in the wireless communication system.

FIG. 3C illustrates a method performed by a second node in a wireless communication system according to an embodiment of the disclosure.

Referring to FIG. 3C, at operation 311, the second node may transmit first information to a first node, and the first information indicates that a problem occurs in or after an Internet Protocol (IP) Multimedia Subsystem (IMS) voice related process of a user equipment (UE). The first node may be an access node in the wireless communication system. The second node may be another access node or a core network node in the wireless communication system.

FIG. 3D illustrates a method performed by a user equipment (UE) in a wireless communication system according to an embodiment of the disclosure.

Referring to FIG. 3D, at operation 321, the UE may generate a report. At operation 322, the UE may transmit the report to an access node in the wireless communication system. The report may be generated in or after an IMS voice related process of the UE.

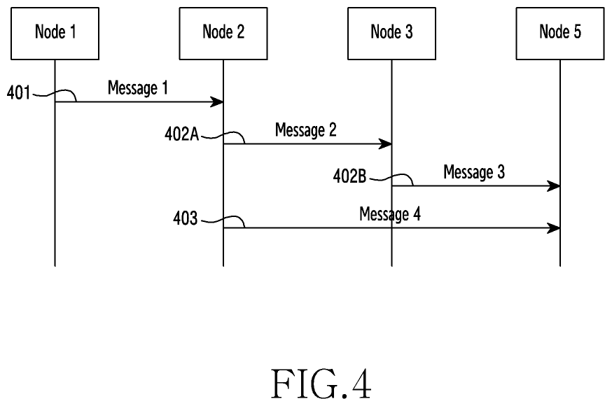

Next, a method of notifying an access node initiating IMS voice fallback that a problem occurs in the IMS voice fallback process will be described with reference to FIGS. 4, 5, 6, 7A, 7B, 8, 9, 10A, 10B, 11A, 11B, 12, and 13. Steps in each of FIGS. 4, 5, 6, 7A, 7B, 8, 9, 10A, 10B, 11A, 11B, 12, and 13 may be fully performed or partially performed, and one or more steps in each of FIGS. 4, 5, 6, 7A, 7B, 8, 9, 10A, 10B, 11A, 11B, 12, and 13 may be performed in combination with one or more steps in another drawing. The aforementioned steps may be performed in the order shown in FIGS. 4, 5, 6, 7A, 7B, 8, 9, 10A, 10B, 11A, 11B, 12, and 13, or in other orders different from those shown in FIGS. 4, 5, 6, 7A, 7B, 8, 9, 10A, 10B, 11A, 11B, 12, and 13.

FIG. 4 is a schematic diagram illustrating a situation where a UE adds IMS voice fallback related information in a generated report in a wireless communication system according to an embodiment of the disclosure.

Herein, Node 1 may be a UE, Node 2 and/or Node 4 may be an access node, such as a gNB or eNB or en-gNB or ng-eNB, and Node 3 may be a core network node, such as an AMF or MME.

FIG. 4 includes the following steps:

Step 401: Node 1 transmits message 1 to Node 2, where the message 1 includes a report generated by Node 1, and the report includes IMS voice fallback related information.

The IMS voice fallback related information includes but is not limited to at least one of the following information:
indication information, indicating that a radio connection failure report generated by the UE is caused by an IMS voice fallback process or an emergency fallback process, or that the information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
frequency information (e.g., ARFCN) used by and/or a cell identifier of a cell initiating the IMS voice fallback process;
a result of measurement on a current serving cell and/or a neighboring cell by the UE;
redirectedCarrierInfo;
cellReselectionPriorities;
measIdleConfig;
service interruption time, for example, a difference between the time when the UE initiates an IMS voice service and the time when the access node transmits an IMS voice fallback indication to the UE, and/or a difference between the time when the access node transmits an IMS voice fallback indication to the UE and the time when establishment of the IMS voice service is completed (for example, establishment of a radio bearer or a QoS flow for transferring data of the IMS voice service is completed), and/or a difference between the time when the UE initiates an IMS voice service and the time when establishment of the IMS voice service is completed.

Herein, the report may be an RLF report, or a CEF report, or SCG failure information (SCGFailurelnformation), or an SHR report, or an RA report, or MCG failure information (MCGFailurelnformation), or a new RRC report.

The message may be an RRC message, such as UE information response (UElnformationResponse).

Node 2 may determine, according to the received information, that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful. Node 2 may generate a report type indicating the problem that occurs in the IMS voice fallback process.

Node 2 may decide, according to the received information, to forward the determination that was made and/or the report to Node 4.

If there is no interface between Node 2 and Node 4, Node 2 may transmit the information to Node 3, and Node 3 transmits the information to Node 4, as shown at step 402.

If there is an interface between Node 2 and Node 4, Node 2 may transmit the information to Node 4 directly, as shown at step 403.

Step 402A: Node 2 transmits message 2 to Node 3, which includes but is not limited to at least one of the following information:
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process;
at least one of other information in IMS voice fallback related information;
the report included in message 1, where the report may also be included in a Container.

The message may be transferred using an Ng interface or an S1 interface.

When an Ng interface is used, the message 1 may be, but not limited to, at least one of the following messages: DOWNLINK RAN CONFIGURATION UPDATE, UPLINK RAN CONFIGURATION TRANSFER, RAN CONFIGURATION UPDATE, RAN CONFIGURATION UPDATE ACKNOWLEDGE, AMF CONFIGURATION UPDATE, AMF CONFIGURATION UPDATE ACKNOWLEDGE, HANDOVER REQUIRED, HANDOVER REQUEST, HANDOVER REQUEST ACKNOWLEDGE, HANDOVER NOTIFY, UE CONTEXT RELEASE REQUEST, INITIAL CONTEXT SETUP REQUEST, PDU SESSION MODIFY RESPONSE, PATH SWITCH REQUEST ACKNOWLEDGE, or a newly defined Ng message.

When the inter-node interface is an S1 interface, the inter-node interface message includes but is not limited to at least one of the following messages: eNB CONFIGURATION UPDATE, MME CONFIGURATION TRANSFER, eNB DIRECT INFORMATION TRANSFER, MME DIRECT INFORMATION TRANSFER, HANDOVER REQUIRED, HANDOVER REQUEST, HANDOVER REQUEST ACKNOWLEDGE, HANDOVER NOTIFY, UE CONTEXT RELEASE REQUEST, INITIAL CONTEXT SETUP REQUEST, PATH SWITCH REQUEST ACKNOWLEDGE, or a newly defined S1 message.

Step 402B: Node 3 transmits message 3 to Node 4. The message 3 includes at least one of the information included in the message 2.

The message may be transferred using an Ng interface or an S1 interface.

When an Ng interface is used, the message 1 may be, but not limited to, at least one of the following messages: DOWNLINK RAN CONFIGURATION UPDATE, UPLINK RAN CONFIGURATION TRANSFER, HANDOVER REQUIRED, HANDOVER REQUEST, HANDOVER REQUEST ACKNOWLEDGE, HANDOVER NOTIFY, UE CONTEXT RELEASE REQUEST, INITIAL CONTEXT SETUP REQUEST, PDU SESSION MODIFY RESPONSE, PATH SWITCH REQUEST ACKNOWLEDGE, or a newly defined Ng message.

When the inter-node interface is an S1 interface, the inter-node interface message includes but is not limited to at least one of the following messages: eNB CONFIGURATION UPDATE, MME CONFIGURATION TRANSFER, eNB DIRECT INFORMATION TRANSFER, MME DIRECT INFORMATION TRANSFER, HANDOVER REQUIRED, HANDOVER REQUEST, HANDOVER REQUEST ACKNOWLEDGE, HANDOVER NOTIFY, UE CONTEXT RELEASE REQUEST, INITIAL CONTEXT SETUP REQUEST, PATH SWITCH REQUEST ACKNOWLEDGE, or a newly defined S1 message.

Step 403: Node 2 transmits message 4 to Node 4. The message 4 includes at least one of the information included in the message 2.

The message may be transferred using an Xn interface or an X2 interface.

When an Xn interface is used, the message may be, but not limited to, at least one of the following messages: ACCESS AND MOBILITY INDICATION, HANDOVER REPORT, FAILURE INDICATION, NG-RAN NODE CONFIGURATION UPDATE, NG-RAN NODE CONFIGURATION UPDATE ACKNOWLEDGE, or a newly defined Xn message.

When an X2 interface is used, the message includes but is not limited to at least one of the following messages: HANDOVER REPORT, RLF INDICATION, ENB CONFIGURATION UPDATE, ENB CONFIGURATION UPDATE ACKNOWLEDGE, or a newly defined X2 message.

Node 2 and/or Node 3 may determine whether a problem occurs in the IMS voice fallback process according to the information in the message 2, so as to optimize network parameters and improve user experience.

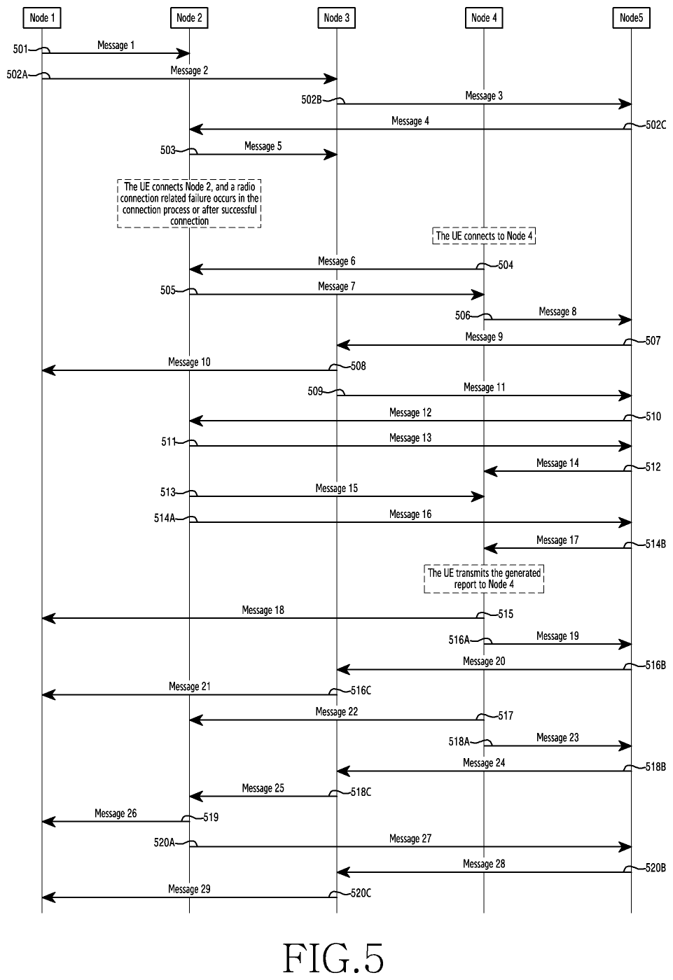

FIG. 5 is a schematic diagram illustrating a situation where a radio connection related failure occurs between a UE and a target cell in an IMS voice fallback handover process and then the UE reconnects to a new cell according to an embodiment of the disclosure.

Herein, Node 1 and/or Node 2 and/or Node 4 may be an access node, such as a gNB or eNB or en-gNB or ng-eNB. Node 3 and/or Node 5 may be a core network node, such as an AMF or MME.

Herein, Node 3 and Node 5 may be the same or different. For example, Node 3 and Node 5 may be the same core network node.

Herein, Node 1 and Node 4 may be the same or different. For example, Node 1 and Node 4 may be the same access node.

FIG. 5 includes the following steps:

If there is an interface between Node 1 and Node 2, step 501 is performed, otherwise, step 502 is performed.

Step 501: Node 1 transmits message 1 to Node 2, where the message 1 includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell.

The message may be transferred using an Xn interface or an X2 interface.

When an Xn interface is used, the message may be, but not limited to, at least one of the following messages: HANDOVER REQUEST, or a newly defined Xn message.

When an X2 interface is used, the message includes but is not limited to at least one of the following messages: HANDOVER REQUEST, or a newly defined X2 message.

Step 502A: Node 1 transmits message 2 to Node 3, where the message 2 includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell.

The message may be transferred using an Ng interface or an S1 interface.

When an Ng interface is used, the message may be, but not limited to, at least one of the following messages: HANDOVER REQUIRED, or a newly defined Ng message.

When an S1 interface is used, the message includes but is not limited to at least one of the following messages: HANDOVER REQUIRED, or a newly defined S1 message.

Step 502B: Node 3 transmits message 3 to Node 5, where the message 3 includes at least one of the information in the message 2.

The message may be transferred using an N11 or N14 interface.

When an N11 interface is used, the message may be, but not limited to, at least one of the following messages: Forward Relocation Request, or a newly defined N11 message.

When an N14 interface is used, the message may be, but not limited to, at least one of the following messages: Namf_Communication_UEContextTransfer_Request, or a newly defined N14 message.

Step 502C: Node 5 transmits message 4 to Node 2, where the message 4 includes at least one of the information in the message 3.

The message may be transferred using an Ng interface or an S1 interface.

When an Ng interface is used, the message may be, but not limited to, at least one of the following messages: HANDOVER REQUEST, or a newly defined Ng message.

When an S1 interface is used, the message includes but is not limited to at least one of the following messages: HANDOVER REQUEST, or a newly defined S1 message.

Node 2 may determine, according to the received information, that an IMS voice fallback handover process has occurred, as well as cell information of the cell initiating the IMS voice fallback process and/or the target cell.

If Node 3 and Node 5 are the same, step 503 is performed.

Step 503: Node 2 transmits message 5 to Node 5. The message 5 includes at least one of the information in the message 1.

The message may be transferred using an Ng interface or an S1 interface.

When an Ng interface is used, the message may be, but not limited to, at least one of the following messages: PATH SWITCH REQUEST, or a newly defined Ng message.

When an S1 interface is used, the message includes but is not limited to at least one of the following messages: PATH SWITCH REQUEST, or a newly defined S1 message.

The UE connects to Node 2, and a radio connection related failure occurs in the connection process or after successful connection.

The UE connects to Node 4.

If there is an interface between Node 4 and Node 2, steps 504 and 505 are performed, and steps 506 to 514 may be omitted; otherwise, the performing continues from step 506.

Step 504: Node 4 transmits message 6 to Node 2. The message includes at least one of the following information:
frequency information (e.g., ARFCN) used by and/or a cell identifier of a reconnected cell.

The message may be transferred using an Xn interface or an X2 interface.

When an Xn interface is used, the message may be, but not limited to, at least one of the following messages: RETRIEVE UE CONTEXT REQUEST, or a newly defined Xn message.

When an X2 interface is used, the message includes but is not limited to at least one of the following messages: RETRIEVE UE CONTEXT REQUEST, or a newly defined X2 message.

According to the received information, Node 2 may determine that there is a problem in the handover process, for example, it may be that the UE fails to connect to a target cell for handover successfully or that the handover is successful but a radio connection failure occurs soon. Further, according to the received information, Node 2 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful. Node 2 may generate a report type indicating the problem that occurs in the IMS voice fallback process.

Step 505: Node 2 transmits message 7 to Node 4. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Xn interface or an X2 interface.

When an Xn interface is used, the message may be, but not limited to, at least one of the following messages: RETRIEVE UE CONTEXT RESPONSE, or a newly defined Xn message.

When an X2 interface is used, the message includes but is not limited to at least one of the following messages: RETRIEVE UE CONTEXT RESPONSE, or a newly defined X2 message.

Step 506: Node 4 transmits message 8 to Node 5. The message includes at least one of the following information:
frequency information (e.g., ARFCN) used by and/or a cell identifier of a reconnected cell.

The message may be transferred using an Ng interface or an S1 interface.

When an Ng interface is used, the message may be, but not limited to, at least one of the following messages: INITIAL UE MESSAGE, or a newly defined Ng message.

When an S1 interface is used, the message includes but is not limited to at least one of the following messages: INITIAL UE MESSAGE, or a newly defined S1 message.

Step 507: Node 5 transmits message 9 to Node 3. The message includes at least one of the information in the message 8.

The message may be transferred using an N11 or N14 interface.

When an N11 interface is used, the message may be, but not limited to, at least one of the following messages: Context Request, or a newly defined N11 message.

When an N14 interface is used, the message may be, but not limited to, at least one of the following messages: Namf_Communication_UEContextTransfer_Request, or a newly defined N14 message.

According to the received information, Node 3 may determine that there is a problem in the handover process, for example, it may be that the UE fails to connect to a target cell for handover successfully or that the handover is successful but a radio connection failure occurs soon. Further, according to the received information, Node 3 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful. Node 3 may generate a report type indicating the problem that occurs in the IMS voice fallback process.

Step 508: Node 3 transmits message 10 to Node 1. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Ng interface or an S1 interface.

When an Ng interface is used, the message may be, but not limited to, at least one of the following messages: ERROR INDICATION, or a newly defined Ng message.

When an S1 interface is used, the message includes but is not limited to at least one of the following messages: a newly defined S1 message.

According to the received information, Node 1 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful.

Node 1 may determine a correct target cell in the handover process according to, for example, the reconnected cell.

Node 1 may optimize network parameters according to the above analysis, thus reducing possibility of similar problems in the future, and improving user experience.

Step 509: Node 3 transmits message 11 to Node 5. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an N11 or N14 interface.

When an N11 interface is used, the message may be, but not limited to, at least one of the following messages: Context Response, or a newly defined N11 message.

When an N14 interface is used, the message may be, but not limited to, at least one of the following messages: Namf_Communication_UEContextTransfer_Response, or a newly defined N14 message.

Step 510: Node 5 transmits message 12 to Node 2. The message includes at least one of the following information:
frequency information (e.g., ARFCN) used by and/or a cell identifier of a reconnected cell.

The message may be transferred using an Ng interface or an S1 interface.

When an Ng interface is used, the message may be, but not limited to, at least one of the following messages: UE CONTEXT RELEASE COMMAND, or a newly defined Ng message.

When an S1 interface is used, the message includes but is not limited to at least one of the following messages: UE CONTEXT RELEASE COMMAND, or a newly defined S1 message.

According to the received information, Node 2 may determine that there is a problem in the handover process, for example, it may be that the UE fails to connect to a target cell for handover successfully or that the handover is successful but a radio connection failure occurs soon. Further, according to the received information, Node 2 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful. Node 2 may generate a report type indicating the problem that occurs in the IMS voice fallback process.

Step 511: Node 2 transmits message 13 to Node 5. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Ng interface or an S1 interface.

When an Ng interface is used, the message may be, but not limited to, at least one of the following messages: UE CONTEXT RELEASE REQUEST, or a newly defined Ng message.

When an S1 interface is used, the message includes but is not limited to at least one of the following messages: UE CONTEXT RELEASE REQUEST, or a newly defined S1 message.

Step 512: Node 5 transmits message 14 to Node 4. The message includes at least one of the information in the message 11 or the message 13.

The message may be transferred using an Ng interface or an S1 interface.

When an Ng interface is used, the message may be, but not limited to, at least one of the following messages: INITIAL CONTEXT SETUP REQUEST, UE CONTEXT MODIFICATION REQUEST, PDU SESSION RESOURCE SETUP REQUEST, PDU SESSION RESOURCE MODIFY REQUEST, UE INFORMATION TRANSFER, DOWNLINK NAS TRANSPORT, or a newly defined Ng message.

When an S1 interface is used, the message includes but is not limited to at least one of the following messages: INITIAL CONTEXT SETUP REQUEST, UE CONTEXT MODIFICATION REQUEST, E-RAB SETUP REQUEST, E-RAB MODIFY REQUEST, UE INFORMATION TRANSFER, DOWNLINK NAS TRANSPORT, or a newly defined S1 message.

If there is an interface between Node 2 and Node 4, step 513 is performed, otherwise, step 514 is performed.

Step 513: Node 2 transmits message 15 to Node 4. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Xn interface or an X2 interface.

When an Xn interface is used, the message may be, but not limited to, at least one of the following messages: FAILURE INDICATION, HANDOVER REPORT, ACCESS AND MOBILITY INDICATION, or a newly defined Ng message.

When an X2 interface is used, the message includes but is not limited to at least one of the following messages: RLF INDICATION, HANDOVER REPORT, or a newly defined X2 message.

Step 514A: Node 2 transmits message 16 to Node 5. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Ng interface or an S1 interface.

When an Ng interface is used, the message may be, but not limited to, at least one of the following messages: UPLINK RAN CONFIGURATION TRANSFER, or a newly defined Ng message.

When an S1 interface is used, the message includes but is not limited to at least one of the following messages: eNB CONFIGURATION TRANSFER, eNB DIRECT INFORMATION TRANSFER, or a newly defined S1 message.

Step 514B: Node 5 transmits message 17 to Node 4. The message includes at least one of the information in the message 16.

The message may be transferred using an Ng interface or an S1 interface.

When an Ng interface is used, the message may be, but not limited to, at least one of the following messages: DOWNLINK RAN CONFIGURATION TRANSFER, or a newly defined Ng message.

When an S1 interface is used, the message includes but is not limited to at least one of the following messages: MME CONFIGURATION TRANSFER, MME DIRECT INFORMATION TRANSFER, or a newly defined S1 message.

According to the received information, Node 4 may determine that there is a problem in the handover process, for example, it may be that the UE fails to connect to a target cell for handover successfully or that the handover is successful but a radio connection failure occurs soon. Further, according to the received information, Node 4 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful. Node 4 may generate a report type indicating the problem that occurs in the IMS voice fallback process.

The UE transmits the generated report to Node 4.

Node 4 may further read and analyze the report generated by the UE, and determine whether the report generated by the UE is related to an IMS voice fallback process based on the IMS voice fallback related information. For example, if in the report generated by the UE, the cell connected prior to the cell in which a radio connection related failure occurs is the same as the cell initiating the IMS voice fallback process, and the cell in which the radio connection related failure occurs is the same as the target cell of the IMS voice fallback process, the report generated by the UE may be considered to be related to the IMS voice fallback process.

Node 4 may transmit the IMS voice fallback related information and/or the received report to Node 1, as shown at step 515 or 516; or transmit the same to Node 2, as shown at step 517 or 518.

If there is an interface between Node 4 and Node 1, step 515 is performed, otherwise, step 516 is performed.

Step 515: Node 4 transmits message 18 to Node 1. The message includes at least one of the following information:
the report generated by the UE; and
at least one of the IMS voice fallback related information.

Herein, the at least one of the IMS voice fallback related information may be, for example:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Xn interface or an X2 interface.

When an Xn interface is used, the message may be, but not limited to, at least one of the following messages: FAILURE INDICATION, HANDOVER REPORT, ACCESS AND MOBILITY INDICATION, or a newly defined Ng message.

When an X2 interface is used, the message includes but is not limited to at least one of the following messages: RLF INDICATION, HANDOVER REPORT, or a newly defined X2 message.

Step 516A: Node 4 transmits message 19 to Node 5. The message includes at least one of the following information:
the report generated by the UE; and
at least one of the IMS voice fallback related information.

Herein, the at least one of the IMS voice fallback related information may be, for example:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Ng interface or an S1 interface.

When an Ng interface is used, the message may be, but not limited to, at least one of the following messages: UPLINK RAN CONFIGURATION TRANSFER, or a newly defined Ng message.

When an S1 interface is used, the message includes but is not limited to at least one of the following messages: eNB CONFIGURATION TRANSFER, eNB DIRECT INFORMATION TRANSFER, or a newly defined S1 message.

Step 516B: Node 5 transmits message 20 to Node 3. The message includes at least one of the information in the message 19.

The message may be transferred using an N11 or N14 interface.

When an N11 interface is used, the message may be, but not limited to, at least one of the following messages: Forward Relocation Request, or a newly defined N11 message.

When an N14 interface is used, the message may be, but not limited to, at least one of the following messages: Namf_Communication_UEContextTransfer_Request, or a newly defined N14 message.

Step 516C: Node 3 transmits message 21 to Node 1. The message includes at least one of the information in the message 20.

The message may be transferred using an Ng interface or an S1 interface.

When an Ng interface is used, the message may be, but not limited to, at least one of the following messages: DOWNLINK RAN CONFIGURATION TRANSFER, or a newly defined Ng message.

When an S1 interface is used, the message includes but is not limited to at least one of the following messages: MME CONFIGURATION TRANSFER, MME DIRECT INFORMATION TRANSFER, or a newly defined S1 message.

According to the received information, Node 1 may determine that there is a problem in the handover process, for example, it may be that the UE fails to connect to a target cell for handover successfully or that the handover is successful but a radio connection failure occurs soon.

Node 1 may further read and analyze the report generated by the UE, and determine whether the report generated by the UE is related to an IMS voice fallback process based on the IMS voice fallback related information. For example, if in the report generated by the UE, the cell connected prior to the cell in which a radio connection related failure occurs is the same as the cell initiating the IMS voice fallback process, and the cell in which the radio connection related failure occurs is the same as the target cell of the IMS voice fallback process, the report generated by the UE may be considered to be related to the IMS voice fallback process.

According to the received information and/or the report generated by the UE, Node 1 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful.

Node 1 may determine a correct target cell in the handover process according to, for example, the reconnected cell and/or a measurement result of the UE in the report generated by the UE.

Node 1 may optimize network parameters according to the above analysis, thus reducing the possibility of occurrence of similar problems in the future, and improving user experience.

Step 517: Node 4 transmits message 22 to Node 2. The message includes at least one of the following information:
the report generated by the UE; and
at least one of the IMS voice fallback related information.

Herein, the at least one of the IMS voice fallback related information may be, for example:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Xn interface or an X2 interface.

When an Xn interface is used, the message may be, but not limited to, at least one of the following messages: FAILURE INDICATION, HANDOVER REPORT, ACCESS AND MOBILITY INDICATION, or a newly defined Ng message.

When an X2 interface is used, the message includes but is not limited to at least one of the following messages: RLF INDICATION, HANDOVER REPORT, or a newly defined X2 message.

Step 518A: Node 4 transmits message 23 to Node 5. The message includes at least one of the following information:
the report generated by the UE; and
at least one of the IMS voice fallback related information.

Herein, the at least one of the IMS voice fallback related information may be, for example:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Ng interface or an S1 interface.

When an Ng interface is used, the message may be, but not limited to, at least one of the following messages: UPLINK RAN CONFIGURATION TRANSFER, or a newly defined Ng message.

When an S1 interface is used, the message includes but is not limited to at least one of the following messages: eNB CONFIGURATION TRANSFER, eNB DIRECT INFORMATION TRANSFER, or a newly defined S1 message.

Step 518B: Node 5 transmits message 24 to Node 3. The message includes at least one of the information in the message 23.

The message may be transferred using an N11 or N14 interface.

When an N11 interface is used, the message may be, but not limited to, at least one of the following messages: Forward Relocation Request, or a newly defined N11 message.

When an N14 interface is used, the message may be, but not limited to, at least one of the following messages: Namf_Communication_UEContextTransfer_Request, or a newly defined N14 message.

Step 518C: Node 3 transmits message 25 to Node 2. The message includes at least one of the information in the message 24.

The message may be transferred using an Ng interface or an S1 interface.

When an Ng interface is used, the message may be, but not limited to, at least one of the following messages: DOWNLINK RAN CONFIGURATION TRANSFER, or a newly defined Ng message.

When an S1 interface is used, the message includes but is not limited to at least one of the following messages: MME CONFIGURATION TRANSFER, MME DIRECT INFORMATION TRANSFER, or a newly defined S1 message.

According to the received information, Node 2 may determine that there is a problem in the handover process, for example, it may be that the UE fails to connect to a target cell for handover successfully or that the handover is successful but a radio connection failure occurs soon.

Node 2 may further read and analyze the report generated by the UE, and determine whether the report generated by the UE is related to an IMS voice fallback process based on the IMS voice fallback related information. For example, if in the report generated by the UE, the cell connected prior to the cell in which a radio connection related failure occurs is the same as the cell initiating the IMS voice fallback process, and the cell in which the radio connection related failure occurs is the same as the target cell of the IMS voice fallback process, the report generated by the UE may be considered to be related to the IMS voice fallback process.

According to the received information and/or the report generated by the UE, Node 2 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful. Node 2 may generate a report type indicating the problem that occurs in the IMS voice fallback process.

If there is an interface between Node 2 and Node 1, step 519 is performed, otherwise, step 520 is performed.

Step 519: Node 2 transmits message 26 to Node 1. The message includes at least one of the following information:
the report generated by the UE; and
at least one of the IMS voice fallback related information.

Herein, the at least one of the IMS voice fallback related information may be, for example:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Xn interface or an X2 interface.

When an Xn interface is used, the message may be, but not limited to, at least one of the following messages: FAILURE INDICATION, HANDOVER REPORT, ACCESS AND MOBILITY INDICATION, or a newly defined Ng message.

When an X2 interface is used, the message includes but is not limited to at least one of the following messages: RLF INDICATION, HANDOVER REPORT, or a newly defined X2 message.

Step 520A: Node 2 transmits message 27 to Node 5. The message includes at least one of the following information:
the report generated by the UE; and
at least one of the IMS voice fallback related information.

Herein, the at least one of the IMS voice fallback related information may be, for example:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Ng interface or an S1 interface.

When an Ng interface is used, the message may be, but not limited to, at least one of the following messages: UPLINK RAN CONFIGURATION TRANSFER, or a newly defined Ng message.

When an S1 interface is used, the message includes but is not limited to at least one of the following messages: eNB CONFIGURATION TRANSFER, eNB DIRECT INFORMATION TRANSFER, or a newly defined S1 message.

Step 520B: Node 5 transmits message 28 to Node 3. The message includes at least one of the information in the message 27.

The message may be transferred using an N11 or N14 interface.

When an N11 interface is used, the message may be, but not limited to, at least one of the following messages: Forward Relocation Request, or a newly defined N11 message.

When an N14 interface is used, the message may be, but not limited to, at least one of the following messages: Namf_Communication_UEContextTransfer_Request, or a newly defined N14 message.

Step 520C: Node 3 transmits message 29 to Node 1. The message includes at least one of the information in the message 28.

The message may be transferred using an Ng interface or an S1 interface.

When an Ng interface is used, the message may be, but not limited to, at least one of the following messages: DOWNLINK RAN CONFIGURATION TRANSFER, or a newly defined Ng message.

When an S1 interface is used, the message includes but is not limited to at least one of the following messages: MME CONFIGURATION TRANSFER, MME DIRECT INFORMATION TRANSFER, or a newly defined S1 message.

According to the received information, Node 1 may determine that there is a problem in the handover process, for example, it may be that the UE fails to connect to a target cell for handover successfully or that the handover is successful but a radio connection failure occurs soon.

Node 1 may further read and analyze the report generated by the UE, and determine whether the report generated by the UE is related to an IMS voice fallback process based on the IMS voice fallback related information. For example, if in the report generated by the UE, the cell connected prior to the cell in which a radio connection related failure occurs is the same as the cell initiating the IMS voice fallback process, and the cell in which the radio connection related failure occurs is the same as the target cell of the IMS voice fallback process, the report generated by the UE may be considered to be related to the IMS voice fallback process.

According to the received information and/or the report generated by the UE, Node 1 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful.

Node 1 may determine a correct target cell in the handover process according to, for example, the reconnected cell and/or a measurement result of the UE in the report generated by the UE.

Node 1 may optimize network parameters according to the above analysis, thus reducing the possibility of occurrence of similar problems in the future, and improving user experience.

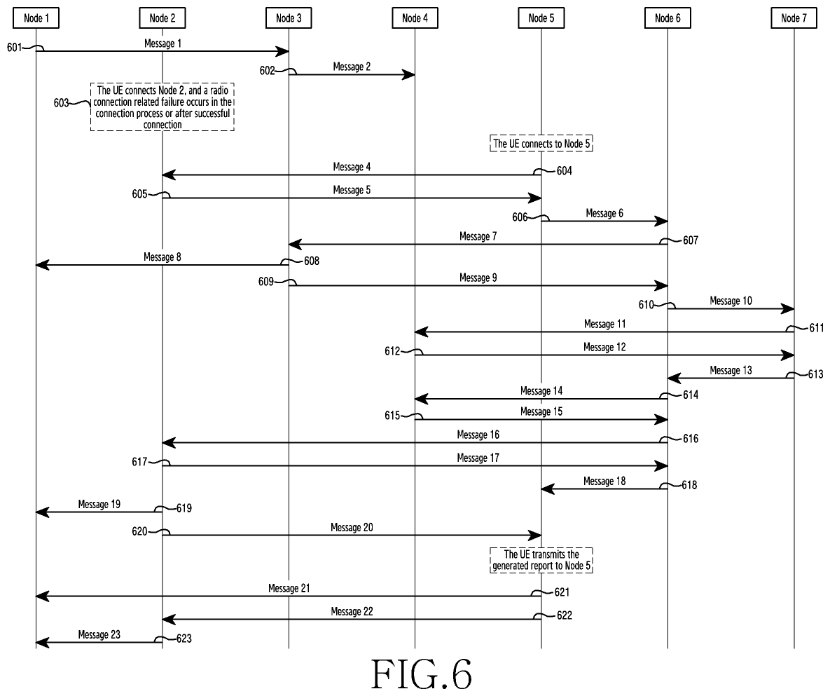

FIG. 6 is a schematic diagram illustrating a situation where a radio connection related failure occurs between a UE and a redirected cell in an IMS voice fallback redirection process and then the UE reconnects to a new cell according to an embodiment of the disclosure.

Herein, Node 1 and/or Node 2 and/or Node 5 may be an access node, such as a gNB or eNB or en-gNB or ng-eNB. Node 3 and/or Node 6 may be a core network node, such as an AMF or MME. Node 4 and/or Node 7 may be a core network node, such as a SMF+PGW−C or SGW.

Herein, Node 3 and Node 6 may be the same or different. For example, Node 3 and Node 6 may be the same core network node.

Herein, Node 1 and Node 5 may be the same or different. For example, Node 1 and Node 5 may be the same access node.

FIG. 6 includes the following steps:

Step 601: Node 1 transmits message 1 to Node 3. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state.

The message may be transferred using an Ng interface or an S1 interface.

When an Ng interface is used, the message may be, but not limited to, at least one of the following messages: PDU SESSION RESOURCE MODIFY RESPONSE, PDU SESSION RESOURCE SETUP RESPONSE, PDU SESSION RESOURCE MODIFY INDICATION, INITIAL CONTEXT SETUP RESPONSE, UE CONTEXT MODIFICATION RESPONSE, UE CONTEXT RELEASE REQUEST, or a newly defined Ng message.

When an S1 interface is used, the message includes but is not limited to at least one of the following messages: E-RAB MODIFY RESPONSE, E-RAB SETUP RESPONSE, E-RAB RELEASE INDICATION, INITIAL CONTEXT SETUP RESPONSE, UE CONTEXT RELEASE REQUEST, UE CONTEXT MODIFICATION RESPONSE, UE CONTEXT MODIFICATION INDICATION, or a newly defined S1 message.

Step 602: Node 3 transmits message 2 to Node 4. The message includes at least one of the information in the message 1.

The message may be transferred using an N11 interface.

When an N11 interface is used, the message may be, but not limited to, at least one of the following messages: Nsmf_PDUSession_UpdateSMContext_Request, or a newly defined N11 message.

Herein, the IMS voice fallback related information may also be included in a container, which is transmitted from Node 1 and forwarded through Node 3 to Node 4.

Node 3 and/or Node 4 may store the received IMS voice fallback related information.

Step 603: The UE selects a cell of Node 2 as the target cell for redirection.

The UE connects to Node 2, and a radio connection related failure occurs in the connection process or after successful connection. The UE generates a report corresponding to the failure.

The radio connection related failure may be, for example, RLF, CEF, SCG failure, or MCG failure.

The UE connects to Node 5.

If there is an interface between Node 5 and Node 2, steps 604 and 605 are performed, and steps 606 to 618 may be omitted; otherwise, the performing continues from step 606.

Step 604: Node 5 transmits message 4 to Node 2. The message includes at least one of the following information:
frequency information (e.g., ARFCN) used by and/or a cell identifier of a reconnected cell.

The message may be transferred using an Xn interface or an X2 interface.

When an Xn interface is used, the message may be, but not limited to, at least one of the following messages: RETRIEVE UE CONTEXT REQUEST, or a newly defined Xn message.

When an X2 interface is used, the message includes but is not limited to at least one of the following messages: RETRIEVE UE CONTEXT REQUEST, or a newly defined X2 message.

According to the received information, Node 2 may determine that there is a problem in the redirection process, for example, it may be that the UE fails to connect to a target cell for redirection successfully or that the redirection is successful but a radio connection failure occurs soon. Further, according to the received information, Node 2 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process. Node 2 may generate a report type indicating the problem that occurs in the IMS voice fallback process.

Step 605: Node 2 transmits message 5 to Node 5. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Xn interface or an X2 interface.

When an Xn interface is used, the message may be, but not limited to, at least one of the following messages: RETRIEVE UE CONTEXT RESPONSE, or a newly defined Xn message.

When an X2 interface is used, the message includes but is not limited to at least one of the following messages: RETRIEVE UE CONTEXT RESPONSE, or a newly defined X2 message.

Step 606: Node 5 transmits message 6 to Node 6. The message includes at least one of the following information:
frequency information (e.g., ARFCN) used by and/or a cell identifier of a reconnected cell.

The message may be transferred using an Ng interface or an S1 interface.

When an Ng interface is used, the message may be, but not limited to, at least one of the following messages: INITIAL UE MESSAGE, or a newly defined Ng message.

When an S1 interface is used, the message includes but is not limited to at least one of the following messages: INITIAL UE MESSAGE, or a newly defined S1 message.

Step 607: Node 6 transmits message 7 to Node 3. The message includes at least one of the information in the message 6.

The message may be transferred using an N11 or N14 interface.

When an N11 interface is used, the message may be, but not limited to, at least one of the following messages: Context Request, or a newly defined N11 message.

When an N14 interface is used, the message may be, but not limited to, at least one of the following messages: Namf_Communication_UEContextTransfer_Request, or a newly defined N14 message.

According to the received information, Node 3 may determine that there is a problem in the redirection process, for example, it may be that the UE fails to connect to a target cell for redirection successfully or that the redirection is successful but a radio connection failure occurs soon. Further, according to the received information, Node 3 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process. Node 3 may generate a report type indicating the problem that occurs in the IMS voice fallback process.

Step 608: Node 3 transmits message 8 to Node 1. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Ng interface or an S1 interface.

When an Ng interface is used, the message may be, but not limited to, at least one of the following messages: ERROR INDICATION, or a newly defined Ng message.

When an S1 interface is used, the message includes but is not limited to at least one of the following messages: a newly defined S1 message.

Step 609: Node 3 transmits message 9 to Node 6. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an N11 or N14 interface.

When an N11 interface is used, the message may be, but not limited to, at least one of the following messages: Context Response, or a newly defined N11 message.

When an N14 interface is used, the message may be, but not limited to, at least one of the following messages: Namf_Communication_UEContextTransfer_Response, or a newly defined N14 message.

Step 610: Node 6 transmits message 10 to Node 7. The message includes at least one of the following information:
frequency information (e.g., ARFCN) used by and/or a cell identifier of a reconnected cell.

The message may be transferred using an S11 interface.

When an S11 interface is used, the message may be, but not limited to, at least one of the following messages: Create Session Request, or a newly defined S11 message.

Step 611: Node 7 transmits message 11 to Node 4. The message includes at least one of the information in the message 10.

The message may be transferred using an S5 or S8 interface.

When an S5 or S8 interface is used, the message may be, but not limited to, at least one of the following messages: Create Session Request, or a newly defined S5 or S8 message.

Node 4 may generate new IMS voice fallback related information according to the stored IMS voice fallback related information.

Step 612: Node 4 transmits message 12 to Node 7. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an S5 or S8 interface.

When an S5 or S8 interface is used, the message may be, but not limited to, at least one of the following messages: Create Session Response, or a newly defined S5 or S8 message.

Step 613: Node 7 transmits message 13 to Node 6. The message includes at least one of the information in the message 12.

The message may be transferred using an S11 interface.

When an S11 interface is used, the message may be, but not limited to, at least one of the following messages: Create Session Response, or a newly defined S11 message.

Step 614: Node 6 may also transmit message 14 to Node 4. The message includes at least one of the following information:
frequency information (e.g., ARFCN) used by and/or a cell identifier of a reconnected cell.

The message may be transferred using an N11 interface.

When an N11 interface is used, the message may be, but not limited to, at least one of the following messages: Nsmf_PDUSession_CreateSMContext_Request, Nsmf_PDUSession_UpdateSMContext_Request, Nsmf_PDUSession_RetrieveSMContext_Request, Nsmf_PDUSession_Retrieve_Request, or a newly defined N11 message.

Node 4 may generate new IMS voice fallback related information according to the stored IMS voice fallback related information.

Step 615: Node 4 transmits message 15 to Node 6. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an N11 interface.

When an N11 interface is used, the message may be, but not limited to, at least one of the following messages: Nsmf_PDUSession_CreateSMContext_Response, Nsmf_PDUSession_UpdateSMContext_Response, Nsmf_PDUSession_RetrieveSMContext_Response, Nsmf_PDUSession_Retrieve_Response, or a newly defined N11 message.

Step 616: Node 6 transmits message 16 to Node 2. The message includes at least one of the following information:
frequency information (e.g., ARFCN) used by and/or a cell identifier of a reconnected cell.

The message may be transferred using an Ng interface or an S1 interface.

When an Ng interface is used, the message may be, but not limited to, at least one of the following messages: UE CONTEXT RELEASE COMMAND, or a newly defined Ng message.

When an S1 interface is used, the message includes but is not limited to at least one of the following messages: UE CONTEXT RELEASE COMMAND, or a newly defined S1 message.

Node 2 may generate new IMS voice fallback related information according to the stored IMS voice fallback related information.

Step 617: Node 2 transmits message 17 to Node 6. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Ng interface or an S1 interface.

When an Ng interface is used, the message may be, but not limited to, at least one of the following messages: UE CONTEXT RELEASE COMPLETE, UE CONTEXT RELEASE REQUEST, or a newly defined Ng message.

When an S1 interface is used, the message includes but is not limited to at least one of the following messages: UE CONTEXT RELEASE COMPLETE, UE CONTEXT RELEASE REQUEST, or a newly defined S1 message.

Based on the above steps, Node 6 may obtain the IMS voice fallback related information.

Step 618: Node 6 transmits message 18 to Node 5. The message includes at least one of the obtained IMS voice fallback related information.

The message may be transferred using an Ng interface or an S1 interface.

When an Ng interface is used, the message may be, but not limited to, at least one of the following messages: INITIAL CONTEXT SETUP REQUEST, PDU SESSION RESOURCE MODIFY REQUEST, PDU SESSION RESOURCE SETUP REQUEST, UE CONTEXT MODIFICATION REQUEST, UE INFORMATION TRANSFER, DOWNLINK NAS TRANSPORT, AMF CONFIGURATION UPDATE, DOWNLINK RAN CONFIGURATION TRANSFER, or a newly defined Ng message.

When an S1 interface is used, the message includes but is not limited to at least one of the following messages: INITIAL CONTEXT SETUP REQUEST, E-RAB MODIFY REQUEST, E-RAB SETUP REQUEST, UE CONTEXT MODIFICATION REQUEST, UE INFORMATION TRANSFER, DOWNLINK NAS TRANSPORT, MME DIRECT INFORMATION TRANSFER, MME CONFIGURATION TRANSFER, or a newly defined S1 message.

Based on the above steps, according to the received information, Node 2 may determine that there is a problem in the redirection process, for example, it may be that the UE fails to connect to a target cell for redirection successfully or that the redirection is successful but a radio connection failure occurs soon. Further, according to the received information, Node 2 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process. Node 2 may generate a report type indicating the problem that occurs in the IMS voice fallback process.

Step 619: Node 2 transmits message 19 to Node 1. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

Node 2 may also transmit the IMS voice fallback related information to Node 5.

Step 620: Node 2 transmits message 20 to Node 5. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

Based on the above steps, Node 5 may obtain the IMS voice fallback related information. Based on the information, Node 5 may determine that there may be a problem in the redirection process, for example, it may be that IMS voice fallback redirection fails or IMS voice fallback redirection is redirection to a wrong cell, and the UE may have generated a corresponding report.

Node 5 may require the UE to transmit the generated report.

The UE transmits the generated report to Node 5.

Node 5 may further read and analyze the report generated by the UE, and determine whether the report generated by the UE is related to an IMS voice fallback process based on the IMS voice fallback related information. For example, if the frequency information used by the cell in which a radio connection related failure occurs is the same as the frequency information used for redirection, and the frequency information used by the reconnected cell is different from the frequency information used for redirection, the report generated by the UE may be considered to be related to the IMS voice fallback process.

According to the received information and/or the report generated by the UE, Node 5 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

Step 621: Node 5 transmits message 21 to Node 1. The message includes at least one of the following information:
the report generated by the UE; and
at least one of the IMS voice fallback related information.

Herein, the at least one of the IMS voice fallback related information may be, for example:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Xn interface or an X2 interface.

When an Xn interface is used, the message may be, but not limited to, at least one of the following messages: FAILURE INDICATION, HANDOVER REPORT, ACCESS AND MOBILITY INDICATION, or a newly defined Ng message.

When an X2 interface is used, the message includes but is not limited to at least one of the following messages: RLF INDICATION, HANDOVER REPORT, or a newly defined X2 message.

Step 622: Node 5 transmits message 22 to Node 2. The message includes at least one of the following information:
the report generated by the UE; and
at least one of the IMS voice fallback related information.

Herein, the at least one of the IMS voice fallback related information may be, for example:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Xn interface or an X2 interface.

When an Xn interface is used, the message may be, but not limited to, at least one of the following messages: FAILURE INDICATION, HANDOVER REPORT, ACCESS AND MOBILITY INDICATION, or a newly defined Ng message.

When an X2 interface is used, the message includes but is not limited to at least one of the following messages: RLF INDICATION, HANDOVER REPORT, or a newly defined X2 message.

Based on the received information, Node 2 may determine that there may be a problem in the redirection process, for example, it may be that IMS voice fallback redirection fails or IMS voice fallback redirection is redirection to a wrong cell, and the UE may have generated a corresponding report.

Node 2 may read and analyze the report generated by the UE, and determine whether the report generated by the UE is related to an IMS voice fallback process based on the IMS voice fallback related information. For example, if the frequency information used by the cell in which a radio connection related failure occurs is the same as the frequency information used for redirection, and the frequency information used by the reconnected cell is different from the frequency information used for redirection, the report generated by the UE may be considered to be related to the IMS voice fallback process.

According to the received information and/or the report generated by the UE, Node 2 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

Step 623: Node 5 transmits message 23 to Node 2. The message includes at least one of the following information:
the report generated by the UE; and
at least one of the IMS voice fallback related information.

Herein, the at least one of the IMS voice fallback related information may be, for example:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback handover is successful, or an IMS voice fallback handover is successful, or an emergency fallback fails, or a secondary cell is added too early due to an IMS voice service configuration process, or a wrong secondary cell is added due to an IMS voice service configuration process.

The message may be transferred using an Xn interface or an X2 interface.

When an Xn interface is used, the message may be, but not limited to, at least one of the following messages: FAILURE INDICATION, HANDOVER REPORT, ACCESS AND MOBILITY INDICATION, or a newly defined Ng message.

When an X2 interface is used, the message includes but is not limited to at least one of the following messages: RLF INDICATION, HANDOVER REPORT, or a newly defined X2 message.

Based on the received information, Node 1 may determine that there may be a problem in the redirection process, for example, it may be that IMS voice fallback redirection fails or IMS voice fallback redirection is redirection to a wrong cell, and the UE may have generated a corresponding report.

Node 1 may read and analyze the report generated by the UE, and determine whether the report generated by the UE is related to an IMS voice fallback process based on the IMS voice fallback related information. For example, if the frequency information used by the cell in which a radio connection related failure occurs is the same as the frequency information used for redirection, and the frequency information used by the reconnected cell is different from the frequency information used for redirection, the report generated by the UE may be considered to be related to the IMS voice fallback process.

According to the received information and/or the report generated by the UE, Node 1 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

Node 1 may determine the correct redirectedCarrierInfo and/or cellReselectionPriorities and/or measIdleConfig in the redirection process according to, for example, the frequency information used by the reconnected cell and/or the measurement result of the UE in the report generated by the UE.

Node 1 may optimize network parameters according to the above analysis, thus reducing the possibility of occurrence of similar problems in the future, and improving user experience.

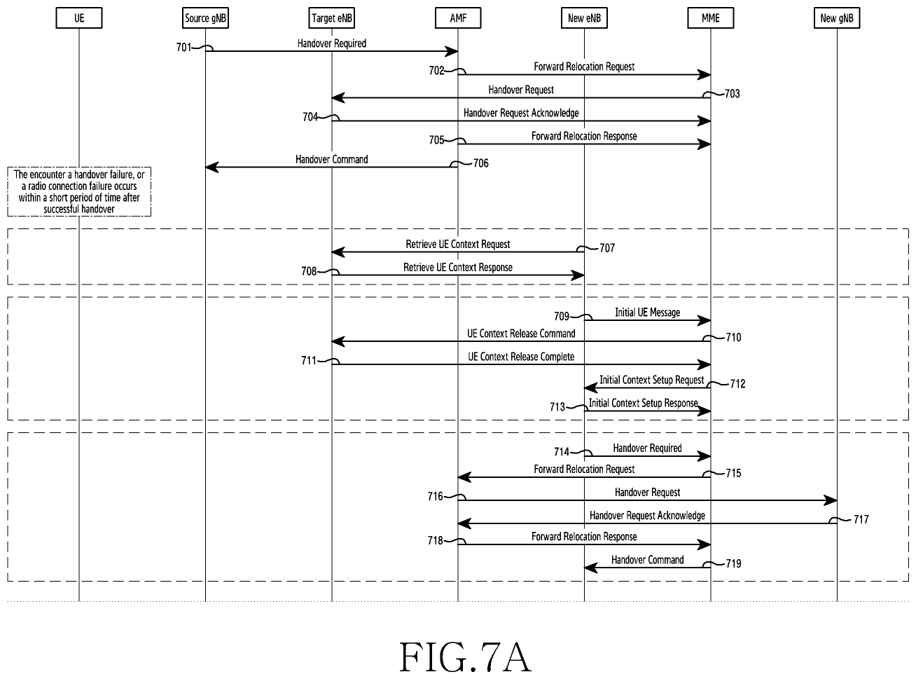

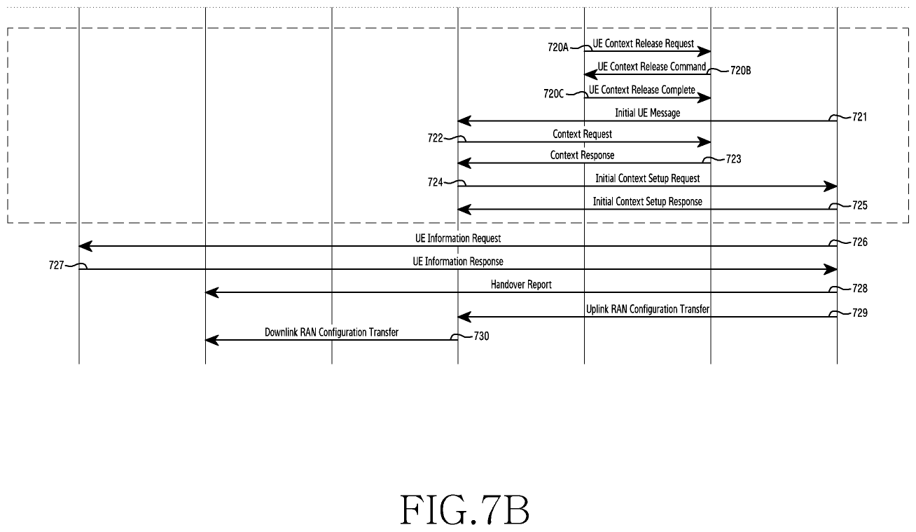

FIG. 7A is a schematic diagram illustrating a situation where a UE performs an IMS voice fallback process, switches from a 5G network to a 4G network, and connects to the 5G network again according to an embodiment of the disclosure.

FIG. 7A includes the following steps:

The UE connects to a source gNB. The source gNB decides to initiate an IMS voice fallback process, where the process is handover.

Step 701: The source gNB transmits a Handover Required to an AMF.

The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell.

The information may also be included in a container, such as a Source to Target Transparent Container.

Step 702: The AMF transmits a Forward Relocation Request to an MME. The message includes at least one of the information in the previous message.

Step 703: The MME transmits a Handover Request to a target eNB. The message includes at least one of the information in the message of step 701.

Step 704: The target eNB transmits a Handover Request Acknowledge to the MME.

Step 705: The AMF transmits a Forward Relocation Response to the MME.

Step 706: The AMF transmits a Handover Command to the source gNB.

The source gNB requires the UE to perform handover, but handover failure occurs, or the UE is successfully handed over but a radio connection failure occurs within a short period of time. The UE generates an RLF report.

The UE connects to a new eNB.

If the UE connects to the new eNB through an RRC re-establishment process, steps 707 and 708 are performed, and steps 709 to 713 are omitted; otherwise, the execution starts from step 709.

Step 707: The new eNB transmits a Retrieve UE Context Request to the target eNB, where the message includes at least one of the following information:
frequency information (e.g., ARFCN) used by and/or a cell identifier of a reconnected cell.

According to the received information, the target eNB may determine that there is a problem in the handover process, for example, it may be that the UE fails to connect to a target cell for handover successfully or that the handover is successful but a radio connection failure occurs soon. Further, according to the received information, the target eNB may determine that a problem related to IMS voice fallback occurs, for example, it may be that an IMS voice fallback handover is too early, or an IMS voice fallback handover is a handover to a wrong cell.

The target eNB may generate or update the IMS voice fallback related information. The target eNB may generate a report type indicating the problem that occurs in the IMS voice fallback process.

Step 708: The target eNB transmits a Retrieve UE Context Response to the new eNB. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

Step 709: The new eNB transmits an Initial UE Message to the MME. The message includes at least one of the following information:

frequency information (e.g., ARFCN) used by and/or a cell identifier of a reconnected cell.

Step 710: The MME transmits a UE Context Release Command to the target eNB. The message includes at least one of the following information:
frequency information (e.g., ARFCN) used by and/or a cell identifier of a reconnected cell.

According to the received information, the target eNB may determine that there is a problem in the handover process, for example, it may be that the UE fails to connect to a target cell for handover successfully or that the handover is successful but a radio connection failure occurs soon. Further, according to the received information, the target eNB may determine that a problem related to IMS voice fallback occurs, for example, it may be that an IMS voice fallback handover is too early, or an IMS voice fallback handover is a handover to a wrong cell.

The target eNB may generate or update the IMS voice fallback related information. The target eNB may generate a report type indicating the problem that occurs in the IMS voice fallback process.

Step 711: The target eNB transmits a UE Context Release Complete to the MME. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

Step 712: The MME transmits an Initial Context Setup Request to the new eNB. The message includes at least one of the information in the previous message.

The message may also be UE CONTEXT MODIFICATION REQUEST, UE INFORMATION TRANSFER, MME CONFIGURATION TRANSFER, or a newly defined S1 message.

Step 713: The new eNB transmits an Initial Context Setup Response to the MME.

The new eNB stores the received IMS voice fallback related information.

The UE may reconnect to the 5G network in two methods. In Method 1, a handover process is utilized; and in Method 2, the UE returns to an idle state and then connects to the 5G network.

Herein, Method 1 is as shown at steps 714 to 719, and Method 2 is as shown at steps 720 to 725 in FIG. 7B.

Step 714: The new eNB transmits a Handover Required to the MME. The message includes at least one of the IMS voice fallback related information stored by the new eNB.

The included information may also be stored in a container, for example, a Source to Target Transparent Container.

Step 715: The MME transmits a Forward Relocation Request to the AMF. The message includes at least one of the information in the previous message.

Step 716: The AMF transmits a Handover Request to a new gNB. The message includes at least one of the information in the previous message.

Step 717: The new gNB transmits a Handover Request Acknowledge to the AMF.

Step 718: The AMF transmits a Forward Relocation Response to the MME.

Step 719: The MME transmits a Handover Command to the new eNB.

Step 719 in FIG. 7A leads to Step 720A in FIG. 7B.

FIG. 7B is a schematic diagram illustrating a situation where a UE performs an IMS voice fallback process, switches from a 5G network to a 4G network, and connects to the 5G network again according to an embodiment of the disclosure.

FIG. 7B includes the following steps:

Step 720A: The new eNB transmits a UE Context Release Request to the MME. The message includes IMS voice fallback related information stored by the new eNB.

Step 720B: The MME transmits a UE Context Release Command to the new eNB.

Step 720C: The new eNB transmits a UE Context Release Complete to the MME. The message may also include IMS voice fallback related information stored by the new eNB.

The MME stores the received IMS voice fallback related information.

Step 721: The UE connects to the new gNB. The new gNB transmits an Initial UE Message to the AMF.

Step 722: The AMF transmits a Forward Relocation Request to the MME.

Step 723: The MME transmits a Forward Relocation Response to the AMF. The message includes at least one of the following information:

at least one of information of the IMS voice fallback related information stored by the MME.

Step 724: The AMF transmits an Initial Context Setup Request to the new gNB. The message includes at least one of the information in the previous message.

Step 725: The new gNB transmits an Initial Context Setup Response to the AMF.

According to the above steps, the new gNB may obtain the IMS voice fallback related information.

According to the received information, the new gNB may determine that a problem related to IMS voice fallback occurs, for example, it may be that an IMS voice fallback handover is too early, or an IMS voice fallback handover is a handover to a wrong cell, and the UE may have generated a corresponding report.

Step 726: The new gNB requires the UE to transmit the generated RLF report.

Step 727: The UE transmits the generated RLF report to the new gNB.

The new gNB may read and analyze the report generated by the UE, and determine whether the report generated by the UE is related to an IMS voice fallback process based on the IMS voice fallback related information. For example, if in the report generated by the UE, the cell connected prior to the cell in which a radio connection related failure occurs is the same as the cell initiating the IMS voice fallback process, and the cell in which the radio connection related failure occurs is the same as the target cell of the IMS voice fallback process, the report generated by the UE may be considered to be related to the IMS voice fallback process.

The new gNB may decide to transmit the received IMS voice fallback related information and/or the report generated by the UE to a node initiating IMS voice fallback, that is, the source gNB, so that the source gNB may perform self-optimization.

If there is an Xn interface between the new gNB and the source gNB, step 728 is performed; otherwise, steps 729 and 730 are performed.

Step 728: The new gNB transmits a Handover Report to the source gNB. The message includes at least one of the following information:

the report generated by the UE; and

at least one of information of the IMS voice fallback related information.

Step 729: The new gNB transmits an UPLINK RAN CONFIGURATION TRANSFER to the AMF. The message includes at least one of the following information:
the report generated by the UE; and
at least one of information of the IMS voice fallback related information.

Step 730: The AMF transmits a DOWNLINK RAN CONFIGURATION TRANSFER to the source gNB. The message includes at least one of the information in the previous message.

According to the received information, the source gNB may determine that a problem related to IMS voice fallback occurs, for example, it may be that an IMS voice fallback handover is too early, or an IMS voice fallback handover is a handover to a wrong cell, and the UE may have generated a corresponding report.

The source gNB may read and analyze the report generated by the UE, and determine whether the report generated by the UE is related to an IMS voice fallback process based on the IMS voice fallback related information. For example, if in the report generated by the UE, the cell connected prior to the cell in which a radio connection related failure occurs is the same as the cell initiating the IMS voice fallback process, and the cell in which the radio connection related failure occurs is the same as the target cell of the IMS voice fallback process, the report generated by the UE may be considered to be related to the IMS voice fallback process.

Therefore, the source gNB may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful.

The source gNB may determine that the target cell for the IMS voice fallback handover process is selected improperly. In addition, the source gNB may determine a correct target cell in the handover process according to, for example, the reconnected cell and/or a measurement result of the UE in the report generated by the UE.

The source gNB may optimize network parameters according to the above analysis, thus reducing the possibility of occurrence of similar problems in the future, and improving user experience.

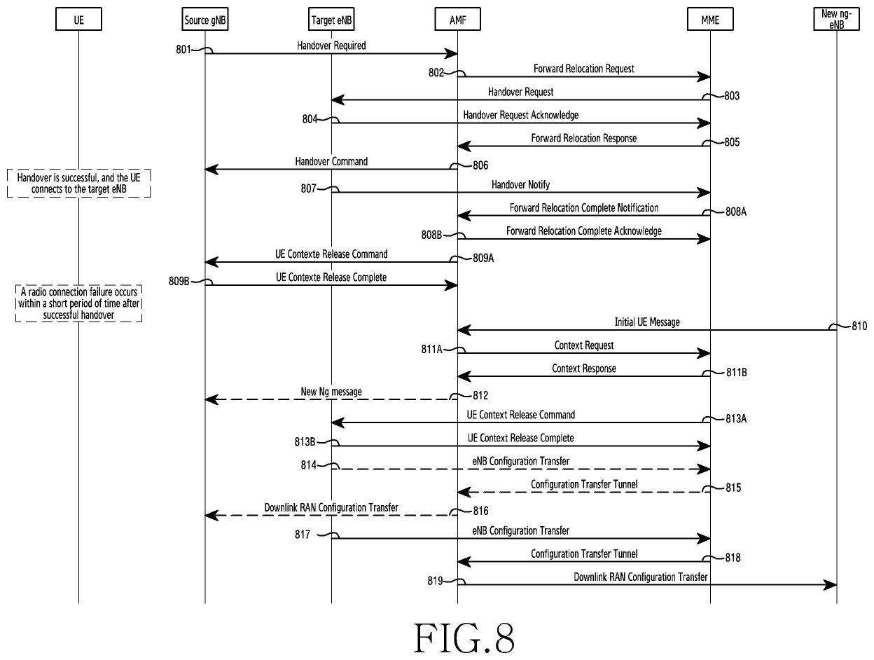

FIG. 8 is a schematic diagram illustrating another situation where a UE performs an IMS voice fallback process, switches from a 5G network to a 4G network, and connects to the 5G network again according to an embodiment of the disclosure.

FIG. 8 includes the following steps:

The UE connects to a source gNB. The source gNB decides to initiate an IMS voice fallback process, where the process is handover.

Step 801: The source gNB transmits a Handover Required to an AMF.

The message includes IMS voice fallback related information, which is included in a container, such as a Source to Target Transparent Container.

Herein, the IMS voice fallback related information is at least one of the following information:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell.

Step 802: The AMF transmits a Forward Relocation Request to an MME.

Step 803: The MME transmits a Handover Request to a target eNB.

Step 804: The target eNB reads the container to obtain the IMS voice fallback related information.

The target eNB stores the received IMS voice fallback related information.

The target eNB transmits a Handover Request Acknowledge to the MME. The message includes at least one of the received IMS voice fallback related information.

The MME stores the received IMS voice fallback related information.

Step 805: The MME transmits a Forward Relocation Response to the AMF.

Step 806: The AMF transmits a Handover Command to the source gNB.

The UE connects to the target eNB.

Step 807: The target eNB transmits a Handover Notify to the MME. The message includes at least one of the received IMS voice fallback related information.

Step 808A: The MME transmits a Forward Relocation Complete Notification to the AMF.

Step 808B: The AMF transmits a Forward Relocation Complete Acknowledge to the MME.

Step 809A: The AMF transmits a UE Context Release Command to the source gNB.

Step 809B: The source gNB transmits a UE Context Release Complete to the AMF.

The UE encounters a radio connection failure within a short period of time after successful handover. The UE generates a corresponding RLF report.

The UE connects to a new ng-eNB.

Step 810: The new ng-eNB transmits an Initial UE Message to the AMF. The message includes at least one of the following information:
frequency information (e.g., ARFCN) used by and/or a cell identifier of a reconnected cell.

Step 811A: The AMF transmits a Context Request to the MME. The message includes at least one of the information in the previous message.

According to the received information, the MME may determine that there is a problem in the handover process, for example, it may be that the UE fails to connect to a target cell for handover successfully or that the handover is successful but a radio connection failure occurs soon. Further, according to the received information, the MME may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful.

The MME updates the stored IMS voice fallback related information with the related information of the reconnected cell and/or the determined report type. The MME may generate a report type indicating the problem that occurs in the IMS voice fallback process.

Step 811B: The MME transmits a Context Response to the AMF. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

According to the received information, the AMF may determine that there is a problem in the handover process, for example, it may be that the UE fails to connect to a target cell for handover successfully or that the handover is successful but a radio connection failure occurs soon. Further, according to the received information, the AMF may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful.

Step 812: The AMF transmits a newly defined Ng message to the source gNB, such as Access and Mobility Indication. The message includes at least one of the received IMS voice fallback related information.

According to the received information, the source gNB may determine that a problem related to IMS voice fallback occurs, for example, it may be that an IMS voice fallback handover is too early, or an IMS voice fallback handover is a handover to a wrong cell, or handover is successful, or an IMS voice fallback handover is successful.

The source gNB may determine that the target cell for the IMS voice fallback handover process is selected improperly. In addition, the source gNB may determine a correct target cell in the handover process according to, for example, the related information of the reconnected cell.

Step 813A: The MME transmits a UE Context Release Command to the target eNB. The message includes at least one of the following information:
frequency information (e.g., ARFCN) used by and/or a cell identifier of a reconnected cell.

According to the received information and/or the stored IMS voice fallback related information, the target eNB may determine that there is a problem in the handover process, for example, it may be that the UE fails to connect to a target cell for handover successfully or that the handover is successful but a radio connection failure occurs soon. Further, according to the received information, the target eNB may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful.

The target eNB updates the stored IMS voice fallback related information with the related information of the reconnected cell and/or the determined report type. The target eNB may generate a report type indicating the problem that occurs in the IMS voice fallback process.

Step 813B: The target eNB transmits a UE Context Release Complete to the MME.

Step 814: The target eNB transmits an eNB CONFIGURATION TRANSFER to the MME. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

Step 815: The MME transmits a Configuration Transfer Tunnel to the AMF. The message includes at least one of the information in the previous message.

Step 816: The AMF transmits a DOWNLINK RAN CONFIGURATION TRANSFER to the source gNB. The message includes at least one of the information in the previous message.

According to the received information, the source gNB may determine that a problem related to IMS voice fallback occurs, for example, it may be that an IMS voice fallback handover is too early, or an IMS voice fallback handover is a handover to a wrong cell, or handover is successful, or an IMS voice fallback handover is successful.

The source gNB may determine that the target cell for the IMS voice fallback handover process is selected improperly. In addition, the source gNB may determine a correct target cell in the handover process according to, for example, the related information of the reconnected cell.

Steps 817 to 818 are the same as steps 814 and 815.

Step 819: The AMF transmits a DOWNLINK RAN CONFIGURATION TRANSFER to the new ng-eNB. The message includes at least one of the information in the previous message.

According to the received information, the new ng-eNB may determine that a problem related to IMS voice fallback occurs, for example, it may be that an IMS voice fallback handover is too early, or an IMS voice fallback handover is a handover to a wrong cell, and the UE may have generated a corresponding report.

The new ng-eNB may require the UE to transmit the generated report, and transmit the received IMS voice fallback related information and/or the report generated by the UE to the source gNB, so that the source gNB may perform self-optimization. The process may refer to steps 726 to 730 in FIG. 7B, which will not be described here.

According to the received information, the source gNB may determine that a problem related to IMS voice fallback occurs, for example, it may be that an IMS voice fallback handover is too early, or an IMS voice fallback handover is a handover to a wrong cell, and the UE may have generated a corresponding report.

The source gNB may read and analyze the report generated by the UE, and determine whether the report generated by the UE is related to an IMS voice fallback process based on the IMS voice fallback related information. For example, if in the report generated by the UE, the cell connected prior to the cell in which a radio connection related failure occurs is the same as the cell initiating the IMS voice fallback process, and the cell in which the radio connection related failure occurs is the same as the target cell of the IMS voice fallback process, the report generated by the UE may be considered to be related to the IMS voice fallback process.

Therefore, the source gNB may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful.

The source gNB may determine that the target cell for the IMS voice fallback handover process is selected improperly. In addition, the source gNB may determine a correct target cell in the handover process according to, for example, the reconnected cell and/or a measurement result of the UE in the report generated by the UE.

The source gNB may optimize network parameters according to the above analysis, thus reducing the possibility of occurrence of similar problems in the future, and improving user experience.

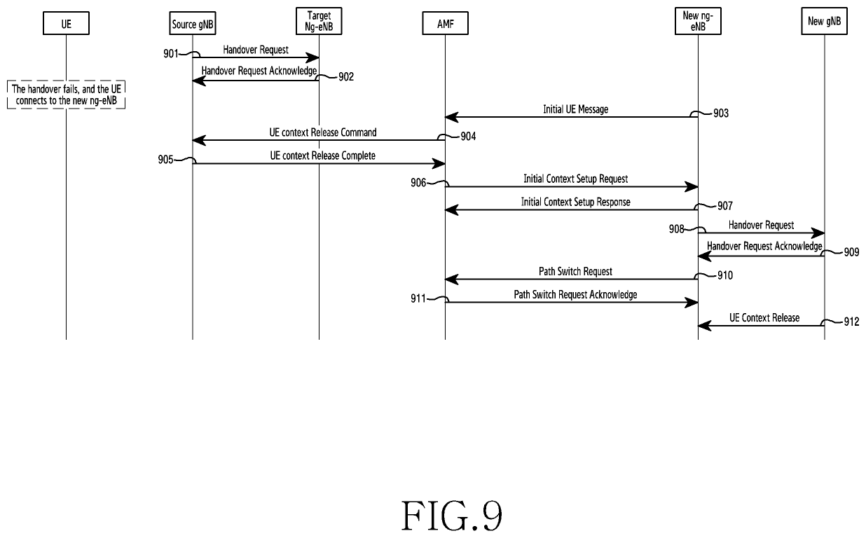

FIG. 9 is a schematic diagram illustrating a situation where a UE performs an IMS voice fallback process, switches from a gNB to an ng-eNB, and connects to a gNB again according to an embodiment of the disclosure.

Herein, there is an Xn interface between a source gNB and a target ng-eNB, and there is an Xn interface between a new ng-eNB and a new gNB.

FIG. 9 includes the following steps:

Step 901: The source gNB decides to switch the UE to the target ng-eNB.

The source gNB transmits a Handover Request to the target ng-eNB. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell.

Step 902: The target ng-eNB transmits a Handover Request Acknowledge to the source gNB.

The handover fails, and the UE connects to the new ng-eNB.

Step 903: The new ng-eNB transmits an Initial UE Message to the AMF. The message includes at least one of the following information:
frequency information (e.g., ARFCN) used by and/or a cell identifier of a reconnected cell.

Step 904: The AMF transmits a UE Context Release Command to the source gNB, indicating the source gNB to release UE context. The message includes at least one of the following information:
frequency information (e.g., ARFCN) used by and/or a cell identifier of a reconnected cell.

According to the received information, the source gNB may determine that a problem related to IMS voice fallback occurs, for example, it may be that an IMS voice fallback handover is too early, or an IMS voice fallback handover is a handover to a wrong cell, or handover is successful, or an IMS voice fallback handover is successful. The source gNB may generate a report type indicating the problem that occurs in the IMS voice fallback process.

The source gNB may determine that the target cell for the IMS voice fallback handover process is selected improperly. In addition, the source gNB may determine a correct target cell in the handover process according to, for example, the related information of the reconnected cell.

Step 905: The source gNB transmits a UE Context Release Complete to the AMF. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The AMF stores the received IMS voice fallback related information.

Step 906: The AMF transmits an Initial Context Setup Request to the new ng-eNB. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may also be another Ng interface message, such as UE CONTEXT MODIFICATION REQUEST, PDU SESSION RESOURCE SETUP REQUEST, PDU SESSION RESOURCE MODIFY REQUEST, UE INFORMATION TRANSFER, DOWNLINK NAS TRANSPORT, or a new Ng interface message.

The new eg-eNB stores the received IMS voice fallback related information.

According to the received information, the new eg-eNB may determine that a problem related to IMS voice fallback occurs, for example, it may be that an IMS voice fallback handover is too early, or an IMS voice fallback handover is a handover to a wrong cell, or handover is successful, or an IMS voice fallback handover is successful.

The new eg-eNB may determine that the target cell for the IMS voice fallback handover process is selected improperly. In addition, the new eg-eNB may determine a correct target cell in the handover process according to, for example, the related information of the reconnected cell.

The new eg-eNB may update the IMS voice fallback related information.

Step 907: The new ng-eNB transmits an Initial Context Setup Response to the AMF.

The new ng-eNB decides to switch the UE to a new gNB.

Step 908: The new ng-eNB transmits a Handover Request to the new gNB. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a reconnected cell;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The new gNB stores the received IMS voice fallback related information.

According to the received information, the new gNB may determine that a problem related to IMS voice fallback occurs, for example, it may be that an IMS voice fallback handover is too early, or an IMS voice fallback handover is a handover to a wrong cell, or handover is successful, or an IMS voice fallback handover is successful.

The new gNB may determine that the target cell for the IMS voice fallback handover process is selected improperly. In addition, the new gNB may determine a correct target cell in the handover process according to, for example, the related information of the reconnected cell.

The new gNB may update the IMS voice fallback related information.

Step 909: The new gNB transmits a Handover Request Acknowledge to the new ng-eNB.

Step 910: Handover is successful. The new gNB transmits a Path Switch Request to the AMF.

Step 911: The AMF transmits a Path Switch Request Acknowledge to the new gNB. The message includes IMS voice fallback related information stored by the AMF.

Step 912: The new gNB transmits a UE Context Release to the new ng-eNB.

According to the received information, the new gNB may determine that a problem related to IMS voice fallback occurs, for example, it may be that an IMS voice fallback handover is too early, or an IMS voice fallback handover is a handover to a wrong cell, and the UE may have generated a corresponding report.

The new gNB may require the UE to transmit the generated report, and transmit the received IMS voice fallback related information and/or the report generated by the UE to the source gNB, so that the source gNB may perform self-optimization. The process may refer to steps 726 to 730 in FIG. 7B, which will not be described here.

According to the received information, the source gNB may determine that a problem related to IMS voice fallback occurs, for example, it may be that an IMS voice fallback handover is too early, or an IMS voice fallback handover is a handover to a wrong cell, and the UE may have generated a corresponding report.

The source gNB may read and analyze the report generated by the UE, and determine whether the report generated by the UE is related to an IMS voice fallback process based on the IMS voice fallback related information. For example, if in the report generated by the UE, the cell connected prior to the cell in which a radio connection related failure occurs is the same as the cell initiating the IMS voice fallback process, and the cell in which the radio connection related failure occurs is the same as the target cell of the IMS voice fallback process, the report generated by the UE may be considered to be related to the IMS voice fallback process.

Therefore, the source gNB may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful.

The source gNB may determine that the target cell for the IMS voice fallback handover process is selected improperly. In addition, the source gNB may determine a correct target cell in the handover process according to, for example, the reconnected cell and/or a measurement result of the UE in the report generated by the UE.

The source gNB may optimize network parameters according to the above analysis, thus reducing the possibility of occurrence of similar problems in the future, and improving user experience.

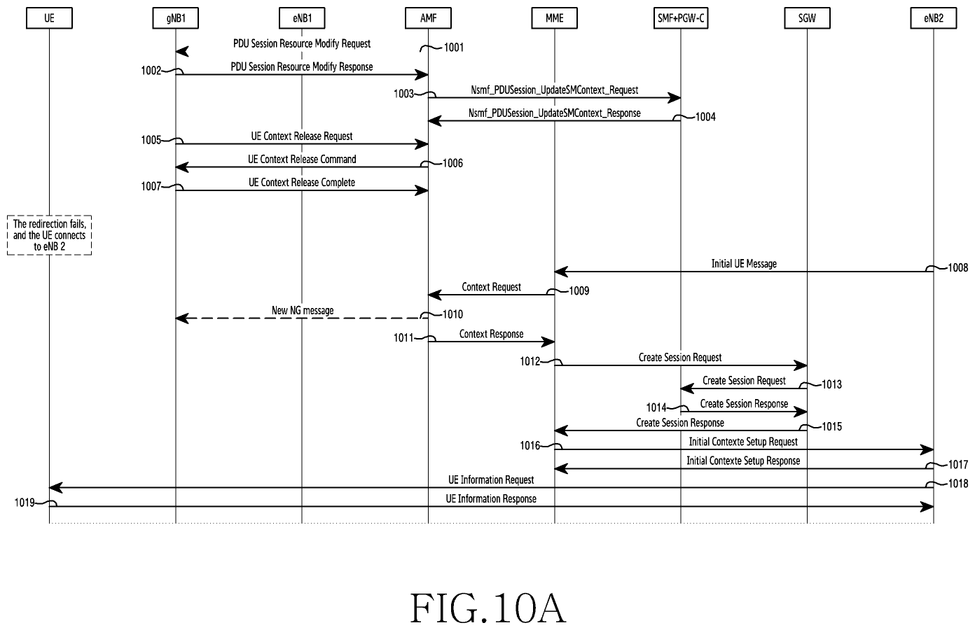

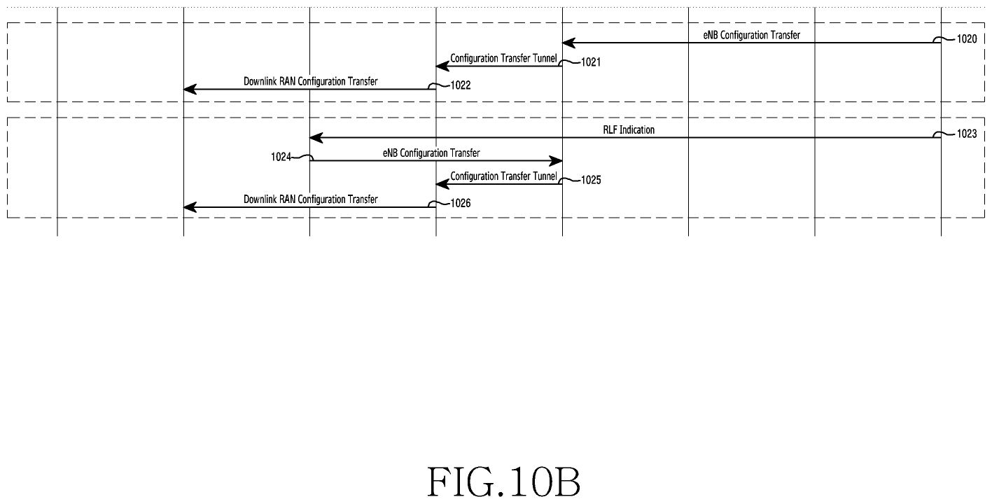

FIG. 10A is a schematic diagram illustrating a situation where a UE performs an IMS voice fallback process, a gNB decides to redirect the UE to eNB1, and the UE connects to eNB2 again according to an embodiment of the disclosure.

Herein, there is an N26 interface between an AMF and an MME, and there is an X2 interface between eNB1 and eNB2.

Herein, SMF+PGW−C is a data plane entity, which has functions of SMF and part of PGW simultaneously.

FIG. 10A includes the following steps:

Step 1001: The AMF transmits a PDU SESSION RESOURCE MODIFY REQUEST to gNB1, requiring to establish a QoS flow carrying an IMS voice service for the UE.

Step 1002: gNB1 decides to initiate an IMS voice fallback redirection process according to information such as its own capabilities, and/or UE capabilities, and/or local configuration information. gNB1 transmits a PDU SESSION RESOURCE MODIFY RESPONSE to the AMF. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information used for redirection (redirectedCarrierInfo);
cell reselection priorities (cellReselectionPriorities);
measurement configuration information (measIdleConfig) used by the UE in an RRC_IDLE or RRC_INACTIVE state.

Herein, the IMS voice fallback related information may be included in a container, such as a PDU Session Resource Modify Unsuccessful Transfer.

Step 1003: The AMF transmits an Nsmf_PDUSession_UpdateSMContext_Request to the SMF+PGW−C. The message includes at least one of the received IMS voice fallback related information, and/or the container.

If the message includes the container, SMF+PGW−C reads IMS voice fallback related information in the container.

SMF+PGW−C stores the received IMS voice fallback related information.

Step 1004: SMF+PGW−C transmits an Nsmf_PDUSession_UpdateSMContext_Response to the AMF.

Step 1005: gNB1 instructs the UE to release RRC connection. gNB1 transmits a UE Context Release Request to the AMF. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information used for redirection (redirectedCarrierInfo);
cell reselection priorities (cellReselectionPriorities);
measurement configuration information (measIdleConfig) used by the UE in an RRC_IDLE or RRC_INACTIVE state.

Step 1006: The AMF transmits a UE Context Release Command to gNB1.

Step 1007: gNB1 transmits a UE Context Release Complete to the AMF. The message may also include at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information used for redirection (redirectedCarrierInfo);
cell reselection priorities (cellReselectionPriorities);
measurement configuration information (measIdleConfig) used by the UE in an RRC_IDLE or RRC_INACTIVE state.

The AMF stores the IMS voice fallback related information received in the above steps.

The UE selects a cell of eNB1 as the target cell for redirection according to the configuration information provided by gNB1 in a process of releasing RRC connection, such as redirectedCarrierInfo and/or cellReselectionPriorities and/or measIdleConfig.

A failure occurs in a process for the UE to connect to eNB1, and the UE generates a CEF report.

The UE connects to eNB2.

Step 1008: eNB2 transmits an Initial UE Message to the MME. The message includes at least one of the following information:
frequency information (e.g., ARFCN) used by and/or a cell identifier of a reconnected cell.

Step 1009: The MME transmits a Context Request to the AMF. The message includes at least one of the following information:
frequency information (e.g., ARFCN) used by and/or a cell identifier of a reconnected cell.

According to the received information, the AMF may determine that there is a problem in the IMS voice fallback redirection process, for example, it may be that the UE fails to connect to a target cell for redirection successfully or that the redirection is successful but a radio connection failure occurs soon. Further, according to the received information, the AMF may determine that a problem related to IMS voice fallback occurs, for example, it may be that IMS voice fallback redirection fails or IMS voice fallback redirection is redirection to a wrong cell.

The AMF may update the stored IMS voice fallback related information with the frequency information and/or the cell identifier used by the reconnected cell, and/or the determination on the problem related to the IMS voice fallback, according to the received information. The AMF may generate a report type indicating the problem that occurs in the IMS voice fallback process.

Step 1010: The AMF transmits a newly defined Ng message to the source gNB, such as Access and Mobility Indication. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a reconnected cell;
frequency information (e.g., ARFCN) used by and/or a cell identifier of a cell initiating the IMS voice fallback process;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback handover is successful, or an IMS voice fallback handover is successful, or an emergency fallback fails, or a secondary cell is added too early due to an IMS voice service configuration process, or a wrong secondary cell is added due to an IMS voice service configuration process.

According to the received information, the source gNB may determine that a problem related to IMS voice fallback occurs, for example, it may be that IMS voice fallback redirection fails or IMS voice fallback redirection is redirection to a wrong cell.

The source gNB may determine that redirectedCarrierInfo and/or cellReselectionPriorities and/or measIdleConfig of the IMS voice fallback redirection process are set improperly. In addition, the source gNB may determine the correct redirectedCarrierInfo and/or cellReselectionPriorities and/or measIdleConfig according to, for example, the related information of the reconnected cell.

Step 1011: The AMF transmits a Context Response to the MME. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a reconnected cell;
frequency information (e.g., ARFCN) used by and/or a cell identifier of a cell initiating the IMS voice fallback process;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

Step 1012: The MME transmits a Create Session Request to the SGW.

The message includes at least one of the following information:
frequency information (e.g., ARFCN) used by and/or a cell identifier of a reconnected cell.

Step 1013: The SGW transmits a Create Session Request to SMF+PGW−C. The message includes at least one of the information in the previous message.

According to the received information, SMF+PGW−C may determine that there is a problem in the IMS voice fallback redirection process, for example, it may be that the UE fails to connect to a target cell for redirection successfully or that the redirection is successful but a radio connection failure occurs soon. Further, according to the received information, SMF+PGW−C may determine that a problem related to IMS voice fallback occurs, for example, it may be that IMS voice fallback redirection fails or IMS voice fallback redirection is redirection to a wrong cell.

SMF+PGW−C may update the stored IMS voice fallback related information with the frequency information and/or the cell identifier used by the reconnected cell, and/or the determination on the problem related to the IMS voice fallback, according to the received information. The SMF+PGW−C may generate a report type indicating the problem that occurs in the IMS voice fallback process.

Step 1014: SMF+PGW−C transmits a Create Session Response to the SGW. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a reconnected cell;
frequency information (e.g., ARFCN) used by and/or a cell identifier of a cell initiating the IMS voice fallback process;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

Step 1015: The SGW transmits a Create Session Response to the MME.

The message includes at least one of the information in the previous message.

The MME may store or update the received IMS voice fallback related information.

Step 1016: The MME transmits an Initial Context Setup Request to eNB2. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a reconnected cell;
frequency information (e.g., ARFCN) used by and/or a cell identifier of a cell initiating the IMS voice fallback process;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

Step 1017: eNB2 transmits an Initial Context Setup Response to the MME.

According to the received information, eNB2 may determine that a problem related to IMS voice fallback occurs, for example, it may be that IMS voice fallback redirection fails or IMS voice fallback redirection is redirection to a wrong cell, and the UE may have generated a corresponding report.

Step 1018: eNB2 requires the UE to transmit the generated report.

The report may be a CEF report or a new RRC report.

The report includes at least one of IMS voice fallback related information, such as:
frequency information (e.g., ARFCN (absolute radio frequency channel number)) and/or a cell identifier used by a cell in which a radio connection related failure occurs;
frequency information (e.g., ARFCN) used by and/or a cell identifier of a reconnected cell;
frequency information (e.g., ARFCN) used by and/or a cell identifier of a cell initiating the IMS voice fallback process;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
service interruption time, for example, a difference between the time when the UE initiates an IMS voice service and the time when the access node transmits an IMS voice fallback indication to the UE, and/or a difference between the time when the access node transmits an IMS voice fallback indication to the UE and the time when establishment of the IMS voice service is completed (for example, establishment of a radio bearer or a QoS flow for transferring data of the IMS voice service is completed), and/or a difference between the time when the UE initiates an IMS voice service and the time when establishment of the IMS voice service is completed.

Step 1019: The UE transmits the generated report to eNB2.

eNB2 may read and analyze the report generated by the UE to obtain, for example, frequency information and/or a cell identifier used by the target cell, and/or frequency information and/or a cell identifier used by the cell in which a radio connection related failure occurs, and/or a result of measurement on a current serving cell and/or a neighboring cell by the UE, and determine whether the report generated by the UE is related to an IMS voice fallback process based on the IMS voice fallback related information, for example, if in the report generated by the UE, the cell connected prior to the cell in which a radio connection related failure occurs is the same as the cell initiating the IMS voice fallback process, and the frequency information used by the cell in which a radio connection related failure occurs is the same as the frequency information used for redirection, the report generated by the UE may be considered to be related to the IMS voice fallback process.

According to the received information, eNB2 may determine that there is a problem in the redirection process, for example, it may be that the UE fails to connect to a target cell for redirection successfully or that the redirection is successful but a radio connection failure occurs soon. Further, according to the received information, eNB2 may determine that a problem related to IMS voice fallback occurs, for example, it may be that IMS voice fallback redirection fails or IMS voice fallback redirection is redirection to a wrong cell.

The eNB2 may, for example, update the IMS voice fallback related information with the determination on the problem related to the IMS voice fallback. The eNB2 may decide to transmit the IMS voice fallback related information and/or the report generated by the UE to the node initiating the IMS voice fallback (in FIGS. 10A and 10B, the node is gNB1), as shown at steps 1020 to 1022; or may also transmit to the node in which a radio connection related failure occurs (in FIGS. 10A and 10B, the node is eNB1), as shown at steps 1023 to 1026 in FIG. 10B.

Step 1019 in FIG. 10A leads to Step 1020 in FIG. 10B.

FIG. 10B is a schematic diagram illustrating a situation where a UE performs an IMS voice fallback process, a gNB decides to redirect the UE to an eNB1, and the UE connects to an eNB2 again according to an embodiment of the disclosure.

FIG. 10B includes the following steps:

Step 1020: eNB2 transmits an eNB CONFIGURATION TRANSFER to the MME. The message includes at least one of the following information:
the report generated by the UE; and
IMS voice fallback related information.

Herein, the IMS voice fallback related information includes at least one of the following information:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

Step 1021: The MME transmits a Configuration Transfer Tunnel to the AMF. The message includes at least one of the information in the previous message.

Step 1022: The AMF transmits a DOWNLINK RAN CONFIGURATION TRANSFER to gNB1. The message includes at least one of the information in the previous message.

Step 1023: eNB2 transmits an RLF Indication to eNB1. The message includes at least one of the following information:
the report generated by the UE; and
IMS voice fallback related information.

Herein, the IMS voice fallback related information includes at least one of the following information:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

According to the received information, eNB1 may determine that a problem related to IMS voice fallback occurs, for example, it may be that IMS voice fallback redirection fails or IMS voice fallback redirection is redirection to a wrong cell, and the UE may have generated a corresponding report.

The eNB1 may read and analyze the report generated by the UE to obtain, for example, frequency information and/or a cell identifier used by the target cell, and/or frequency information and/or a cell identifier used by the cell in which a radio connection related failure occurs, and/or a result of measurement on a current serving cell and/or a neighboring cell by the UE, and determine whether the report generated by the UE is related to an IMS voice fallback process based on the IMS voice fallback related information, for example, if in the report generated by the UE, the cell connected prior to the cell in which a radio connection related failure occurs is the same as the cell initiating the IMS voice fallback process, and the frequency information used by the cell in which a radio connection related failure occurs is the same as the frequency information used for redirection, the report generated by the UE may be considered to be related to the IMS voice fallback process.

According to the received information, eNB1 may determine that there is a problem in the redirection process, for example, it may be that the UE fails to connect to a target cell for redirection successfully or that the redirection is successful but a radio connection failure occurs soon. Further, according to the received information, eNB2 may determine that a problem related to IMS voice fallback occurs, for example, it may be that IMS voice fallback redirection fails or IMS voice fallback redirection is redirection to a wrong cell.

eNB1 may, for example, update the IMS voice fallback related information with the determination on the problem related to the IMS voice fallback.

Step 1024: eNB1 transmits an eNB CONFIGURATION TRANSFER to the MME. The message includes at least one of the following information:
the report generated by the UE; and
IMS voice fallback related information.

Herein, the IMS voice fallback related information includes at least one of the following information:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a cell initiating the IMS voice fallback process;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
a result of measurement on a current serving cell and/or a neighboring cell by the UE;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

Step 1025: The MME transmits a Configuration Transfer Tunnel to the AMF. The message includes at least one of the information in the previous message.

Step 1026: The AMF transmits a DOWNLINK RAN CONFIGURATION TRANSFER to gNB1. The message includes at least one of the information in the previous message.

According to the above steps, gNB1 may determine that a problem related to IMS voice fallback occurs, for example, it may be that IMS voice fallback redirection fails or IMS voice fallback redirection is redirection to a wrong cell, and the UE may have generated a corresponding report.

gNB1 may read and analyze the report generated by the UE to obtain, for example, frequency information and/or a cell identifier used by the target cell, and/or frequency information and/or a cell identifier used by the cell in which a radio connection related failure occurs, and/or a result of measurement on a current serving cell and/or a neighboring cell by the UE, and determine whether the report generated by the UE is related to an IMS voice fallback process based on the IMS voice fallback related information, for example, if in the report generated by the UE, the cell connected prior to the cell in which a radio connection related failure occurs is the same as the cell initiating the IMS voice fallback process, and the frequency information used by the cell in which a radio connection related failure occurs is the same as the frequency information used for redirection, the report generated by the UE may be considered to be related to the IMS voice fallback process.

Therefore, gNB1 may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful.

gNB1 may determine that redirectedCarrierInfo and/or cellReselectionPriorities and/or measIdleConfig of the IMS voice fallback redirection process are set improperly. In addition, gNB1 may determine the correct redirectedCarrierInfo and/or cellReselectionPriorities and/or measIdleConfig according to, for example, the related information of the reconnected cell.

gNB1 may optimize network parameters according to the above analysis, thus reducing the possibility of occurrence of similar problems in the future, and improving user experience.

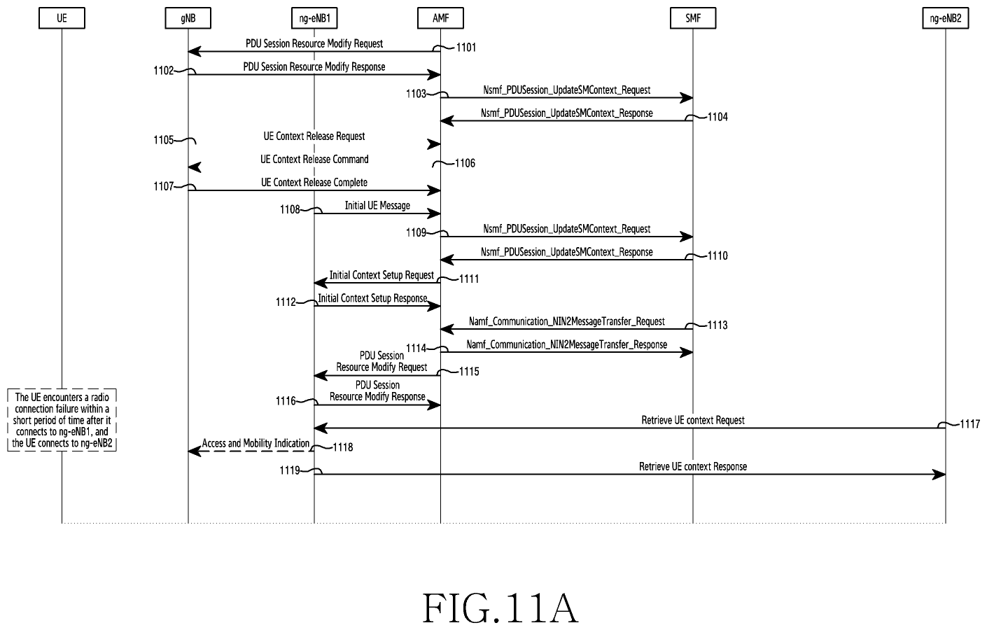

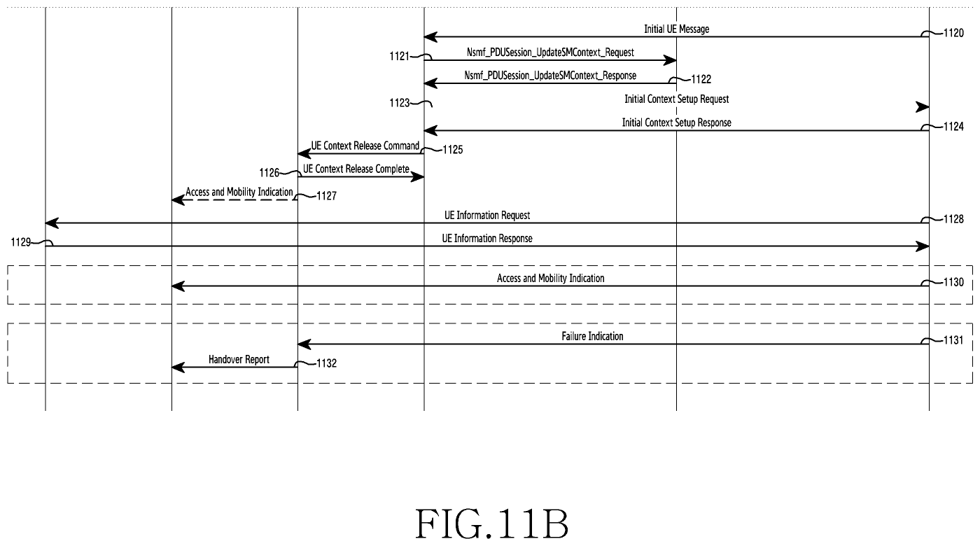

FIG. 11A is a schematic diagram illustrating a situation where a UE performs an IMS voice fallback process, a gNB decides to redirect the UE to an ng-eNB1, and the UE connects to an ng-eNB2 again according to an embodiment of the disclosure.

Herein, there is an Xn interface among the gNB, the ng-eNB1 and the ng-eNB 2.

FIG. 11A includes the following steps:

Steps 1101 to 1107 are the same as steps 1001 to 1007 in FIG. 10A.

UE redirects to the ng-eNB1.

Step 1108: The ng-eNB1 transmits an Initial UE Message to the AMF.

Step 1109: The AMF transmits an Nsmf_PDUSession_UpdateSMContext_Request to the SMF.

Step 1110: The SMF transmits an Nsmf_PDUSession_UpdateSMContext_Response to the AMF. The message includes at least one of IMS voice fallback related information stored by the SMF. The information may also be included in a container, such as a PDU Session Resource Setup Request Transfer.

The AMF may update the stored IMS voice fallback related information according to the received information.

Step 1111: The AMF transmits an Initial Context Setup Request to the ng-eNB1. The message includes at least one of the IMS voice fallback related information held by the AMF, and/or the container received in the previous message.

And if the message includes the container, the ng-eNB1 reads the container to obtain the IMS voice fallback related information.

The ng-eNB1 stores the received IMS voice fallback related information.

Step 1112: The ng-eNB1 transmits an Initial Context Setup Response to the AMF.

Step 1113: The SMF initiates a process of setting IMS voice service. SMF transmits an Namf_Communication_N1N2MessageTransfer_Request to the AMF. The message includes at least one of the IMS voice fallback related information held by the SMF. The information may also be included in a container, such as a PDU Session Resource Modify Request Transfer.

The AMF may update the stored IMS voice fallback related information according to the received information.

Step 1114: The AMF transmits an Namf_Communication_N1N2MessageTransfer_Response to the SMF.

Step 1115: The AMF transmits a PDU SESSION RESOURCE MODIFY REQUEST to the ng-eNB1. The message includes at least one of the IMS voice fallback related information held by the AMF, and/or the container received in the previous message.

If the message includes the container, the ng-eNB1 reads the container to obtain the IMS voice fallback related information.

The ng-eNB1 stores the received IMS voice fallback related information.

Step 1116: The ng-eNB1 transmits a PDU SESSION RESOURCE MODIFY RESPONSE to the AMF.

The UE encounters a radio connection failure within a short period of time after it connects to the ng-eNB1, and the UE generates an RLF report.

The UE connects to the ng-eNB2.

If the UE connects to the new ng-eNB2 through an RRC re-establishment process, steps 1117 to 1119 are performed, and steps 1120 to 1127 in FIG. 11B are omitted; otherwise, the execution starts from step 1120 in FIG. 11B.

Step 1117: The ng-eNB2 transmits a RETRIEVE UE CONTEXT REQUEST to the ng-eNB1. The message includes at least one of the following information:
frequency information (e.g., ARFCN) used by and/or a cell identifier of a reconnected cell.

According to the received information, the ng-eNB1 may determine that there is a problem in the redirection process, for example, it may be that the UE fails to connect to a target cell for redirection successfully or that the redirection is successful but a radio connection failure occurs soon. Further, according to the received information, the ng-eNB1 may determine that a problem related to IMS voice fallback occurs, for example, it may be that IMS voice fallback redirection fails or IMS voice fallback redirection is redirection to a wrong cell.

The ng-eNB1 may, for example, update the IMS voice fallback related information with the determination on the problem related to the IMS voice fallback.

Step 1118: The ng-eNB1 transmits an Access and Mobility Indication to the gNB. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a reconnected cell;
frequency information (e.g., ARFCN) used by and/or a cell identifier of a cell initiating the IMS voice fallback process;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback handover is successful, or an IMS voice fallback handover is successful, or an emergency fallback fails, or a secondary cell is added too early due to an IMS voice service configuration process, or a wrong secondary cell is added due to an IMS voice service configuration process.

The message may also be a Failure Indication, a Handover Report, or a new Xn message.

According to the received information, the gNB may determine that a problem related to IMS voice fallback occurs, for example, it may be that IMS voice fallback redirection fails or IMS voice fallback redirection is redirection to a wrong cell.

The gNB may determine that redirectedCarrierInfo and/or cellReselectionPriorities and/or measIdleConfig of the IMS voice fallback redirection process are set improperly. In addition, the gNB may determine the correct redirectedCarrierInfo and/or cellReselectionPriorities and/or measIdleConfig according to, for example, the related information of the reconnected cell.

Step 1119: The ng-eNB1 transmits an Access and Mobility Indication to the ng-eNB2. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a reconnected cell;
frequency information (e.g., ARFCN) used by and/or a cell identifier of a cell initiating the IMS voice fallback process;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

According to the received information, the ng-eNB2 may determine that a problem related to IMS voice fallback occurs, for example, it may be that IMS voice fallback redirection fails or IMS voice fallback redirection is redirection to a wrong cell.

Step 1119 in FIG. 11A leads to Step 1120 in FIG. 11B.

FIG. 11B is a schematic diagram illustrating a situation where a UE performs an IMS voice fallback process, a gNB decides to redirect the UE to a ng-eNB1, and the UE connects to a ng-eNB2 again according to an embodiment of the disclosure.

FIG. 11B includes the following steps:

Step 1120: The ng-eNB2 transmits an Initial UE Message to the AMF.

The message includes at least one of the following information:
frequency information (e.g., ARFCN) used by and/or a cell identifier of a reconnected cell.

Step 1121: The AMF transmits an Nsmf_PDUSession_UpdateSMContext_Request to the SMF. The message includes at least one of the following information:
frequency information (e.g., ARFCN) used by and/or a cell identifier of a reconnected cell.

According to the received information, the SMF may determine that there is a problem in the redirection process, for example, it may be that the UE fails to connect to a target cell for redirection successfully or that the redirection is successful but a radio connection failure occurs soon. Further, according to the received information, the ng-eNB1 may determine that a problem related to IMS voice fallback occurs, for example, it may be that IMS voice fallback redirection fails or IMS voice fallback redirection is redirection to a wrong cell.

SMF may, for example, update the IMS voice fallback related information with the determination on the problem related to the IMS voice fallback. The SMF may generate a report type indicating the problem that occurs in the IMS voice fallback process.

Step 1122: The SMF transmits an Nsmf_PDUSession_UpdateSMContext_Response to the AMF. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a reconnected cell;
frequency information (e.g., ARFCN) used by and/or a cell identifier of a cell initiating the IMS voice fallback process;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The information may also be included in a container, such as a PDU Session Resource Setup Request Transfer.

The AMF may update the stored IMS voice fallback related information according to the received information.

Step 1123: The AMF transmits an Initial Context Setup Request to the ng-eNB2. The message includes at least one of the IMS voice fallback related information held by the AMF, and/or the container received in the previous message.

If the message includes the container, the ng-eNB2 reads the container to obtain the IMS voice fallback related information.

The ng-eNB2 stores the received IMS voice fallback related information.

Step 1124: The ng-eNB2 transmits an Initial Context Setup Response to the AMF.

Step 1125: The AMF instructs ng-eNB1 to release UE context. The AMF transmits a UE Context Release Command to the ng-eNB1. The message includes at least one of IMS voice fallback related information, such as:
frequency information (e.g., ARFCN) used by and/or a cell identifier of a reconnected cell.

According to the received information, the ng-eNB1 may determine that there is a problem in the redirection process, for example, it may be that the UE fails to connect to a target cell for redirection successfully or that the redirection is successful but a radio connection failure occurs soon. Further, according to the received information, the ng-eNB1 may determine that a problem related to IMS voice fallback occurs, for example, it may be that IMS voice fallback redirection fails or IMS voice fallback redirection is redirection to a wrong cell.

The ng-eNB1 may, for example, update the IMS voice fallback related information with the determination on the problem related to the IMS voice fallback. In step 1126, the ng-eNB1 transmits a UE Context Release Complete to the AMF.

Step 1127 is the same as step 1118 in FIG. 11A.

According to the above steps, the ng-eNB2 obtains the IMS voice fallback related information. According to the received information, the ng-eNB2 may determine that a problem related to IMS voice fallback occurs, for example, it may be that IMS voice fallback redirection fails or IMS voice fallback redirection is redirection to a wrong cell. The ng-eNB2 may also determine that the UE may have generated a corresponding report.

Steps 1128 to 1129 are the same as steps 1018 to 1019 in FIG. 10A.

The ng-eNB2 may read and analyze the report generated by the UE to obtain, for example, frequency information and/or a cell identifier used by the target cell, and/or frequency information and/or a cell identifier used by the cell in which a radio connection related failure occurs, and/or a result of measurement on a current serving cell and/or a neighboring cell by the UE, and determine whether the report generated by the UE is related to an IMS voice fallback process based on the IMS voice fallback related information, for example, if in the report generated by the UE, the cell connected prior to the cell in which a radio connection related failure occurs is the same as the cell initiating the IMS voice fallback process, and the frequency information used by the cell in which a radio connection related failure occurs is the same as the frequency information used for redirection, the report generated by the UE may be considered to be related to the IMS voice fallback process.

According to the received information, the ng-eNB2 may determine that there is a problem in the redirection process, for example, it may be that the UE fails to connect to a target cell for redirection successfully or that the redirection is successful but a radio connection failure occurs soon. Further, according to the received information, the ng-eNB2 may determine that a problem related to IMS voice fallback occurs, for example, it may be that IMS voice fallback redirection fails or IMS voice fallback redirection is redirection to a wrong cell.

The ng-eNB2 may, for example, update the IMS voice fallback related information with the determination on the problem related to the IMS voice fallback.

The ng-eNB2 may decide to transmit the IMS voice fallback related information and/or the report generated by the UE to the node initiating the IMS voice fallback (in FIG. 11B, the node is gNB), as shown at step 1130; or may also transmit to the node in which a radio connection related failure occurs (in FIG. 11B, the node is ng-eNB1), as shown at steps 1131 to 1132.

Step 1130: The ng-eNB2 transmits an Access and Mobility Indication to the gNB. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
frequency information (e.g., ARFCN) used by and/or a cell identifier of a cell initiating the IMS voice fallback process;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

The message may also be a Failure Indication, a Handover Report, or a new Xn message.

Step 1131: The ng-eNB2 transmits a Failure Indication to the ng-eNB1. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
frequency information (e.g., ARFCN) used by and/or a cell identifier of a cell initiating the IMS voice fallback process;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

According to the received information, the ng-eNB1 may determine that a problem related to IMS voice fallback occurs, for example, it may be that IMS voice fallback redirection fails or IMS voice fallback redirection is redirection to a wrong cell. The ng-eNB1 may also determine that the UE may have generated a corresponding report.

The ng-eNB1 may read and analyze the report generated by the UE to obtain, for example, frequency information and/or a cell identifier used by the target cell, and/or frequency information and/or a cell identifier used by the cell in which a radio connection related failure occurs, and/or a result of measurement on a current serving cell and/or a neighboring cell by the UE, and determine whether the report generated by the UE is related to an IMS voice fallback process based on the IMS voice fallback related information, for example, if in the report generated by the UE, the cell connected prior to the cell in which a radio connection related failure occurs is the same as the cell initiating the IMS voice fallback process, and the frequency information used by the cell in which a radio connection related failure occurs is the same as the frequency information used for redirection, the report generated by the UE may be considered to be related to the IMS voice fallback process.

According to the received information, the ng-eNB1 may determine that there is a problem in the redirection process, for example, it may be that the UE fails to connect to a target cell for redirection successfully or that the redirection is successful but a radio connection failure occurs soon. Further, according to the received information, the ng-eNB1 may determine that a problem related to IMS voice fallback occurs, for example, it may be that IMS voice fallback redirection fails or IMS voice fallback redirection is redirection to a wrong cell.

The ng-eNB1 may, for example, update the IMS voice fallback related information with the determination on the problem related to the IMS voice fallback.

Step 1132, the ng-eNB1 transmits a Failure Indication to the gNB. The message includes at least one of IMS voice fallback related information, such as:
indication information, indicating that a report (e.g., a radio connection failure report (e.g., a RLF report)) generated by the UE is caused by an IMS voice fallback process or an emergency fallback process, or that the IMS voice fallback related information is related to an IMS voice fallback process, or indicating that the IMS voice fallback related information is set incorrectly, e.g., a target cell for handover is selected improperly or a redirection frequency is set improperly. Optionally, information that the process is handover or redirection is included;
frequency information (e.g., ARFCN) used by and/or a cell identifier of a target cell;
frequency information (e.g., ARFCN) used by and/or a cell identifier of a cell in which a radio connection related failure occurs;
frequency information (e.g., ARFCN) used by and/or a cell identifier of a reconnected cell;
frequency information (e.g., ARFCN) used by and/or a cell identifier of a cell initiating the IMS voice fallback process;
frequency information used for redirection (redirectedCarrierInfo);
cell reselection priorities (cellReselectionPriorities);
measurement configuration information (measIdleConfig) used by the UE in an RRC_IDLE or RRC_INACTIVE state;
a report type, indicating a problem that occurs in the IMS voice fallback process, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful, or an emergency fallback fails, or a secondary cell is added too early due to an IMS voice service configuration process, or a wrong secondary cell is added due to an IMS voice service configuration process.

According to the above steps, gNB may determine that a problem related to IMS voice fallback occurs, for example, it may be that IMS voice fallback redirection fails or IMS voice fallback redirection is redirection to a wrong cell, and the UE may have generated a corresponding report.

The gNB may read and analyze the report generated by the UE to obtain, for example, frequency information and/or a cell identifier used by the target cell, and/or frequency information and/or a cell identifier used by the cell in which a radio connection related failure occurs, and/or a result of measurement on a current serving cell and/or a neighboring cell by the UE, and determine whether the report generated by the UE is related to an IMS voice fallback process based on the IMS voice fallback related information, for example, if in the report generated by the UE, the cell connected prior to the cell in which a radio connection related failure occurs is the same as the cell initiating the IMS voice fallback process, and the frequency information used by the cell in which a radio connection related failure occurs is the same as the frequency information used for redirection, the report generated by the UE may be considered to be related to the IMS voice fallback process.

Therefore, gNB may determine that a problem related to IMS voice fallback occurs, for example, it may be that an IMS voice fallback handover is too early, or an IMS voice fallback handover is a handover to a wrong cell, or IMS voice fallback redirection fails, or IMS voice fallback redirection is redirection to a wrong cell, or handover is successful, or an IMS voice fallback handover is successful.

gNB may determine that redirectedCarrierInfo and/or cellReselectionPriorities and/or measIdleConfig of the IMS voice fallback redirection process are set improperly. In addition, the gNB may determine the correct redirectedCarrierInfo and/or cellReselectionPriorities and/or measIdleConfig according to, for example, the related information of the reconnected cell.

The gNB may optimize network parameters according to the above analysis, thus reducing the possibility of occurrence of similar problems in the future, and improving user experience.

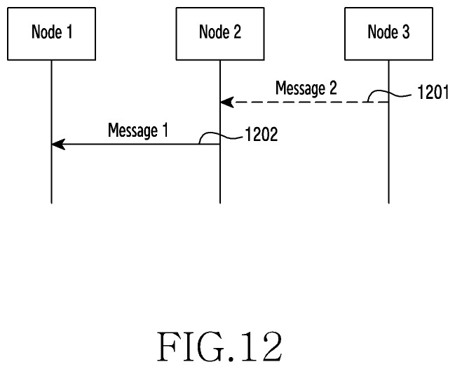

FIG. 12 is a schematic diagram illustrating a situation where an access node broadcasts whether an IMS voice capability is supported according to an embodiment of the disclosure.

Herein, Node 1 may be a UE, Node 2 and Node 3 may be an access nodes, such as a gNB or eNB or en-gNB or ng-eNB. Node 3 may also be a core network node, such as an AMF or MME.

FIG. 12 includes the following steps:

Step 1201: Node 3 transmits message 1 to Node 2. The message 1 includes at least one of the following information:
indication information, indicating whether the core network has a capability of supporting an IMS voice service.

When Node 3 is a core network node, the message may be transferred using an Ng interface or an S1 interface.

When an Ng interface is used, the message may be, but not limited to, at least one of the following messages: NG SETUP RESPONSE, RAN CONFIGURATION UPDATE ACKNOWLEDGE, AMF CONFIGURATION UPDATE, or a newly defined NG message.

When an S1 interface is used, the message includes but is not limited to at least one of the following messages: S1 SETUP RESPONSE, ENB CONFIGURATION UPDATE ACKNOWLEDGE, MME CONFIGURATION UPDATE, or a newly defined S1 message.

When Node 3 is an access node, the message may be transferred using an Xn interface or an X2 interface.

When an Xn interface is used, the message may be, but not limited to, at least one of the following messages: XN SETUP REQUEST, XN SETUP RESPONSE, NG-RAN NODE CONFIGURATION UPDATE, NG-RAN NODE CONFIGURATION UPDATE ACKNOWLEDGE, or a newly defined Xn message.

When an X2 interface is used, the message includes but is not limited to at least one of the following messages: X2 SETUP REQUEST, X2 SETUP RESPONSE, ENB CONFIGURATION UPDATE, ENB CONFIGURATION UPDATE ACKNOWLEDGE, EN-DC X2 SETUP REQUEST, EN-DC X2 SETUP RESPONSE, EN-DC CONFIGURATION UPDATE, EN-DC CONFIGURATION UPDATE ACKNOWLEDGE, EN-DC CONFIGURATION TRANSFER, or a newly defined X2 message.

Step 1202: Node 2 may decide whether it has a capability of supporting an IMS voice service according to the received information and/or local configuration information. Node 2 broadcasts a message 2, which includes at least one of the following information:
indication information, indicating whether this node has a capability of supporting an IMS voice service.

The message may be an RRC message, such as SIB 1.

The UE receives the message 2.

When the UE performs an IMS voice fallback process, such as a redirection process, the UE may decide whether to redirect to a cell of this node according to the message.

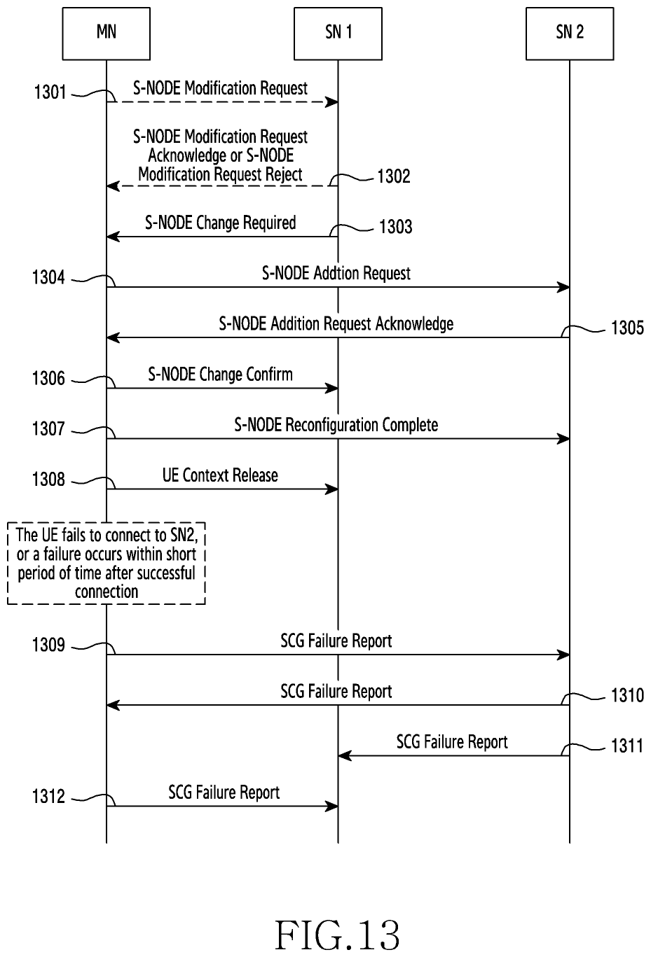

FIG. 13 is a schematic diagram illustrating a situation where a secondary node (SN) selects a target SN while considering an IMS voice service in an SN change process initiated by the SN according to an embodiment of the disclosure.

Herein, an MN (Master Node), SN1 and SN2 may be access nodes, such as eNBs, gNBs, ng-eNBs, or en-gNBs.

FIG. 13 includes the following steps:

Step 1301: The MN transmits an S-NODE MODIFICATION REQUEST to the SN1, requiring to set an IMS voice service, such as a QoS flow with QCI of 1, on the SN1.

Step 1302: SN1 transmits an S-NODE MODIFICATION REQUEST ACKNOWLEDGE or an S-NODE MODIFICATION REQUEST REJECT to the MN.

The message includes at least one of the following information:
indication information, indicating whether the SN has a capability of supporting an IMS voice service.

SN 1 decides to initiate an SN change process.

Step 1303: SN1 transmits an S-NODE CHANGE REQUIRED to the MN, requiring to configure SN2 as a new SN. The message includes at least one of the following information:
indication information, indicating that the SN change process is related to the IMS voice service.

Step 1304: The MN transmits an S-NODE ADDITION REQUEST to the Step 1305: SN2 transmits an S-NODE ADDITION REQUEST ACKNOWLEDGE to the MN.

Step 1306: The MN transmits an S-NODE CHANGE CONFIRM to the SN1.

Step 1307: The MN transmits an S-NODE RECONFIGURATION COMPLETE to the SN2.

Step 1308: The MN transmits a UE CONTEXT RELEASE to the SN1.

The UE fails to connect to the SN2, or a failure occurs within a short period of time after successful connection to the SN2.

The UE generates an SCGFailurelnformation report message. The message includes at least one of IMS voice fallback related information, such as:
indication information, indicating that the report generated by the UE (e.g., a radio connection failure report (e.g., an RLF report)) is related to the IMS voice service;
frequency information (e.g., ARFCN) used by and/or a cell identifier of a cell in which a radio connection related failure occurs;
a result of measurement on a current serving cell and/or a neighboring cell by the UE;
a report type, indicating a problem that occurs in the IMS voice fallback process, for example, it may be that a secondary cell is added too early due to an IMS voice service configuration process, or a wrong secondary cell is added due to an IMS voice service configuration process.

The UE transmits the message to the MN.

The MN may determine that a problem related to IMS voice occurs, for example, a secondary cell is added too early due to an IMS voice service or a wrong secondary cell is added due to an IMS voice service configuration process, and the UE may have generated a corresponding report.

The MN may read and analyze the report generated by the UE to obtain, for example, the frequency information and/or the cell identifier used by the cell in which a radio connection related failure occurs, and/or the result of measurement of the current serving cell and/or neighboring cell by the UE, and/or the indication information indicating that the report generated by the UE (for example, a radio connection failure report (e.g., an RLF report)) is related to the IMS voice service, and determine that the report generated by the UE is related to the IMS voice service.

Step 1309: The MN knows that the UE encounters a radio connection related failure on the SN2. The MN transmits a new Xn message (SCG Failure Report) to the SN2. The message includes at least one of the following information:
the report generated by the UE; and
a node identifier of an SN in which a radio connection related failure occurs;
a node identifier of a node initiating an SN change process; and
IMS voice fallback related information.

Herein, the IMS voice fallback related information includes at least one of the following information:
indication information, indicating that the report generated by the UE (e.g., a radio connection failure report (e.g., an RLF report)) is related to the IMS voice service;
frequency information (e.g., ARFCN) used by and/or a cell identifier of a cell in which a radio connection related failure occurs;
a result of measurement on a current serving cell and/or a neighboring cell by the UE;
a report type, indicating a problem that occurs in the IMS voice fallback process, for example, it may be that a secondary cell is added too early due to an IMS voice service configuration process, or a wrong secondary cell is added due to an IMS voice service configuration process.

The node identifier includes a node ID and/or a cell identifier of a cell to which the node belongs.

The message may also be a Failure Indication, a Handover Report, or an Access and Mobility Indication.

The SN2 may determine that a problem related to IMS voice occurs, for example, a secondary cell is added too early due to an IMS voice service configuration process, or a wrong secondary cell is added due to an IMS voice service configuration process, and the UE may have generated a corresponding report.

The SN2 may read and analyze the report generated by the UE to obtain, for example, the frequency information and/or the cell identifier used by the cell in which a radio connection related failure occurs, and/or the result of measurement of the current serving cell and/or neighboring cell by the UE, and/or the indication information indicating that the report generated by the UE (for example, a radio connection failure report (e.g., an RLF report)) is related to the IMS voice service, and determine that the report generated by the UE is related to the IMS voice service.

The SN2 may update the received IMS voice fallback related information.

The SN2 may notify the MN or the node initiating the SN change (SN1 in this example). If the SN2 notifies the MN or there is no Xn interface between the SN2 and the SN1, step 1310 is performed; and if the SN2 notifies the SN1 and there is an Xn interface between the SN2 and the SN1, step 1311 is performed.

Step 1310: The SN2 transmits a new Xn message (SCG Failure Report) to the MN. The message includes at least one of the following information:
the report generated by the UE;
a node identifier of an SN in which a radio connection related failure occurs;
a node identifier of a node initiating an SN change process; and
IMS voice fallback related information.

Herein, the IMS voice fallback related information includes at least one of the following information:
indication information, indicating that the report generated by the UE (e.g., a radio connection failure report (e.g., an RLF report)) is related to the IMS voice service;
frequency information (e.g., ARFCN) used by and/or a cell identifier of a cell in which a radio connection related failure occurs;
a result of measurement on a current serving cell and/or a neighboring cell by the UE;
a report type, indicating a problem that occurs in the IMS voice fallback process, for example, it may be that a secondary cell is added too early due to an IMS voice service configuration process, or a wrong secondary cell is added due to an IMS voice service configuration process.

The message may also be a Failure Indication, a Handover Report, or an Access and Mobility Indication.

Step 1311: The SN2 transmits a new Xn message (SCG Failure Report) to the SN1. The message includes at least one of the following information:
the report generated by the UE;
a node identifier of an SN in which a radio connection related failure occurs;
a node identifier of a node initiating an SN change process; and
IMS voice fallback related information.

Herein, the IMS voice fallback related information includes at least one of the following information:
indication information, indicating that the report generated by the UE (e.g., a radio connection failure report (e.g., an RLF report)) is related to the IMS voice service;
frequency information (e.g., ARFCN) used by and/or a cell identifier of a cell in which a radio connection related failure occurs;
a result of measurement on a current serving cell and/or a neighboring cell by the UE;
a report type, indicating a problem that occurs in the IMS voice fallback process, for example, it may be that a secondary cell is added too early due to an IMS voice service configuration process, or a wrong secondary cell is added due to an IMS voice service configuration process.

The message may also be a Failure Indication, a Handover Report, or an Access and Mobility Indication.

The MN may update the received IMS voice fallback related information, and then perform step 1312.

Step 1312: The MN transmits a new Xn message (SCG Failure Report) to the SN1. The message includes at least one of the following information:
the report generated by the UE;
a node identifier of an SN in which a radio connection related failure occurs;
a node identifier of a node initiating an SN change process; and
IMS voice fallback related information.

Herein, the IMS voice fallback related information includes at least one of the following information:
indication information, indicating that the report generated by the UE (e.g., a radio connection failure report (e.g., an RLF report)) is related to the IMS voice service;
frequency information (e.g., ARFCN) used by and/or a cell identifier of a cell in which a radio connection related failure occurs;
a result of measurement on a current serving cell and/or a neighboring cell by the UE;
a report type, indicating a problem that occurs in the IMS voice fallback process, for example, it may be that a secondary cell is added too early due to an IMS voice service configuration process, or a wrong secondary cell is added due to an IMS voice service configuration process.

The message may also be a Failure Indication, a Handover Report, or an Access and Mobility Indication.

The MN may also ignore steps 1309 to 1311 and directly perform step 1312.

According to the above steps, SN1 may determine that a problem related to IMS voice occurs, for example, a secondary cell is added too early due to an IMS voice service configuration process, or a wrong secondary cell is added due to an IMS voice service configuration process, and the UE may have generated a corresponding report.

The SN1 may read and analyze the report generated by the UE to obtain, for example, the frequency information and/or the cell identifier used by the cell in which a radio connection related failure occurs, and/or the result of measurement on the current serving cell and/or neighboring cell by the UE, and/or the indication information indicating that the report is related to the IMS voice service, and determine that the report generated by the UE is related to the IMS voice service.

The SN1 may determine that the new SN is not properly selected in the SN change process related to the IMS voice service. In addition, the SN1 may determine a correct new SN according to, for example, the measurement result of the UE.

The SN1 may optimize network parameters according to the above analysis, thus reducing the possibility of occurrence of similar problems in the future, and improving user experience.

Similarly, the MN may also determine that the new SN is not properly selected in the SN change process related to the IMS voice service. In addition, the MN may also determine a correct new SN according to, for example, the measurement result of the UE. When a similar situation comes, the MN may determine whether the new SN selected by the current SN is appropriate and take appropriate actions, for example, rejecting the SN change process initiated by the SN.

The MN may optimize network parameters according to the above analysis, thus reducing the possibility of occurrence of similar problems in the future, and improving user experience.

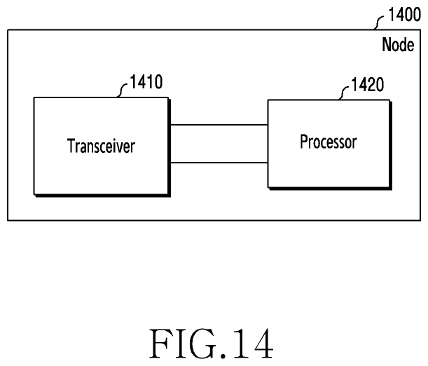

FIG. 14 illustrates a block diagram of the structure of a Node 1400 according to an embodiment of the disclosure.

Referring to FIG. 14, Node 1400 includes a transceiver 1410 and a processor 1420. The transceiver 1410 is configured to transmit and receive data/signals. The processor 1420 is configured to control the transceiver 1410 to perform various methods of the disclosure or any combination of one or more steps of each method. Node 1400 may be implemented in software, hardware, firmware, or a combination thereof. Node 1400 may be a UE, an access node or a core network node, etc.

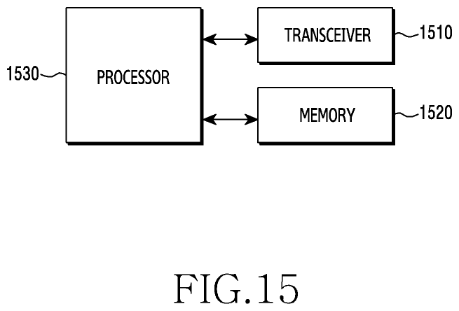

FIG. 15 illustrates a structure of a UE according to an embodiment of the disclosure.

Referring to FIG. 15, the UE according to an embodiment may include a transceiver 1510, a memory 1520, and a processor 1530. The transceiver 1510, the memory 1520, and the processor 1530 of the UE may operate according to a communication method of the UE described above. However, the components of the UE are not limited thereto. For example, the UE may include more or fewer components than those described above. In addition, the processor 1530, the transceiver 1510, and the memory 1520 may be implemented as a single chip. Also, the processor 1530 may include at least one processor. Furthermore, the UE of FIG. 15 corresponds to the UE of FIG. 1.

The transceiver 1510 collectively refers to a UE receiver and a UE transmitter, and may transmit/receive a signal to/from a base station or a network entity. The signal transmitted or received to or from the base station or a network entity may include control information and data. The transceiver 1510 may include a RF transmitter for up-converting and amplifying a frequency of a transmitted signal, and a RF receiver for amplifying low-noise and down-converting a frequency of a received signal. However, this is only an example of the transceiver 1510 and components of the transceiver 1510 are not limited to the RF transmitter and the RF receiver.

Also, the transceiver 1510 may receive and output, to the processor 1530, a signal through a wireless channel, and transmit a signal output from the processor 1530 through the wireless channel.

The memory 1520 may store a program and data required for operations of the UE. Also, the memory 1520 may store control information or data included in a signal obtained by the UE. The memory 1520 may be a storage medium, such as read-only memory (ROM), random access memory (RAM), a hard disk, a CD-ROM, and a DVD, or a combination of storage media.

The processor 1530 may control a series of processes such that the UE operates as described above. For example, the transceiver 1510 may receive a data signal including a control signal transmitted by the base station or the network entity, and the processor 1530 may determine a result of receiving the control signal and the data signal transmitted by the base station or the network entity.

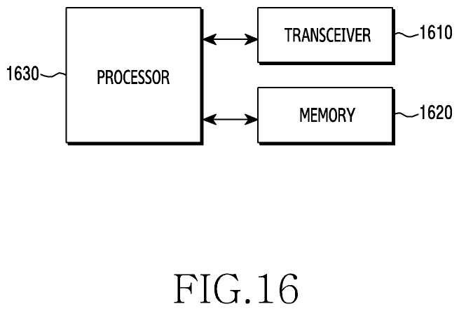

FIG. 16 illustrates a structure of a base station according to an embodiment of the disclosure.

Referring to FIG. 16, the base station according to an embodiment may include a transceiver 1610, a memory 1620, and a processor 1630. The transceiver 1610, the memory 1620, and the processor 1630 of the base station may operate according to a communication method of the base station described above. However, the components of the base station are not limited thereto. For example, the base station may include more or fewer components than those described above. In addition, the processor 1630, the transceiver 1610, and the memory 1620 may be implemented as a single chip. Also, the processor 1630 may include at least one processor. Furthermore, the base station of FIG. 16 corresponds to the BS (e.g., Source gNB, Target eNB, New gNB, or New eNB of FIGS. 7A and 7B).

The transceiver 1610 collectively refers to a base station receiver and a base station transmitter, and may transmit/receive a signal to/from a user equipment (UE) or a network entity. The signal transmitted or received to or from the terminal or a network entity may include control information and data. The transceiver 1610 may include a RF transmitter for up-converting and amplifying a frequency of a transmitted signal, and a RF receiver for amplifying low-noise and down-converting a frequency of a received signal. However, this is only an example of the transceiver 1610 and components of the transceiver 1610 are not limited to the RF transmitter and the RF receiver.

Also, the transceiver 1610 may receive and output, to the processor 1630, a signal through a wireless channel, and transmit a signal output from the processor 1630 through the wireless channel.

The memory 1620 may store a program and data required for operations of the base station. Also, the memory 1620 may store control information or data included in a signal obtained by the base station. The memory 1620 may be a storage medium, such as read-only memory (ROM), random access memory (RAM), a hard disk, a CD-ROM, and a DVD, or a combination of storage media.

The processor 1630 may control a series of processes such that the base station operates as described above. For example, the transceiver 1610 may receive a data signal including a control signal transmitted by the terminal, and the processor 1630 may determine a result of receiving the control signal and the data signal transmitted by the terminal.

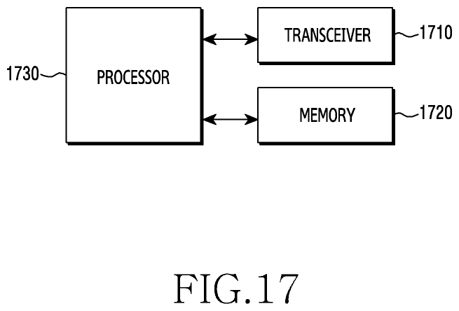

FIG. 17 is a block diagram illustrating a structure of a network entity according to an embodiment of the disclosure.

Referring to FIG. 17, the network entity of the disclosure may include a transceiver 1710, a memory 1720, and a processor 1730. The transceiver 1710, the memory 1720, and the processor 1730 of the network entity may operate according to a communication method of the network entity described above. However, the components of the terminal are not limited thereto. For example, the network entity may include more or fewer components than those described above. In addition, the processor 1730, the transceiver 1710, and the memory 1720 may be implemented as a single chip. Also, the processor 830 may include at least one processor. Furthermore, the network entity illustrated in FIG. 17 may correspond to the network entity (e.g., AMF entity (203) or SMF entity (205) illustrated in FIG. 2).

The transceiver 1710 collectively refers to a network entity receiver and a network entity transmitter, and may transmit/receive a signal to/from a base station or a UE. The signal transmitted or received to or from the base station or the UE may include control information and data. In this regard, the transceiver 1710 may include a RF transmitter for up-converting and amplifying a frequency of a transmitted signal, and a RF receiver for amplifying low-noise and down-converting a frequency of a received signal. However, this is only an example of the transceiver 1710 and components of the transceiver 1710 are not limited to the RF transmitter and the RF receiver.

Also, the transceiver 1710 may receive and output, to the processor 1730, a signal through a wireless channel, and transmit a signal output from the processor 1730 through the wireless channel.

The memory 1720 may store a program and data required for operations of the network entity. Also, the memory 1720 may store control information or data included in a signal obtained by the network entity. The memory 1720 may be a storage medium, such as ROM, RAM, a hard disk, a CD-ROM, and a DVD, or a combination of storage media.

The processor 1730 may control a series of processes such that the network entity operates as described above. For example, the transceiver 1710 may receive a data signal including a control signal, and the processor 1730 may determine a result of receiving the data signal.

According to an aspect of the disclosure, there is provided a method performed by a user equipment (UE) in a wireless communication system, including: generating a report; and transmitting the report to an access node in the wireless communication system, wherein the report is generated in or after an Internet Protocol (IP) Multimedia Subsystem (IMS) voice related process of the UE.

Optionally, the report includes first information, and the first information includes at least one of the following: indication information, indicating that the report generated by the UE is caused by an IMS voice fallback process or an IMS voice service configuration process or an emergency fallback process, or indicating that the first information is related to an IMS voice fallback process, or indicating that IMS voice fallback related information is set incorrectly; frequency information and/or a cell identifier used by a target cell; frequency information and/or a cell identifier used by a cell in which a radio connection related failure occurs; frequency information and/or a cell identifier used by a reconnected cell; frequency information and/or a cell identifier used by a cell initiating an IMS voice fallback process; a result of measurement on a current serving cell and/or a neighboring cell by the UE; frequency information used for redirection; cell reselection priorities; measurement configuration information used by the UE in an RRC_IDLE or RRC_INACTIVE state; service interruption time, including at least one of the following: a difference between the time when the UE initiates an IMS voice service and the time when the access node transmits an IMS voice fallback indication to the UE, a difference between the time when the access node transmits an IMS voice fallback indication to the UE and the time when establishment of the IMS voice service is completed, and a difference between the time when the UE initiates an IMS voice service and the time when establishment of the IMS voice service is completed; and a report type, indicating a problem that occurs in an IMS voice fallback process or an IMS voice service configuration process or an emergency fallback process, wherein the problems include at least one of the following: IMS voice fallback handover is too early, IMS voice fallback handover is handover to a wrong cell, IMS voice fallback redirection fails, IMS voice fallback redirection is redirection to a wrong cell, handover is successful, IMS voice fallback handover is successful, emergency fallback fails, a secondary cell is added too early due to an IMS voice service configuration process, or a wrong secondary cell is added due to an IMS voice service configuration process.

Optionally, the indication information also indicates that the IMS voice fallback process or IMS voice service configuration process or emergency fallback process is handover or redirection.

According to an aspect of the disclosure, there is provided a method performed by a first node in a wireless communication system, including: obtaining first information from at least one other node in the wireless communication system, which indicates that a problem occurs in or after an Internet Protocol (IP) Multimedia Subsystem (IMS) voice related process of a user equipment (UE); and optimizing IMS voice fallback related parameters in response to obtaining the first information, wherein the first node is an access node, and the at least one other node is a UE or another access node or a core network node in the wireless communication system.

Optionally, the first information includes at least one of the following: indication information, indicating that a report generated by the UE is caused by an IMS voice fallback process or an IMS voice service configuration process or an emergency fallback process, or indicating that the first information is related to an IMS voice fallback process or an IMS voice service configuration process or an emergency fallback process, or indicating that IMS voice fallback related information is set incorrectly; frequency information and/or a cell identifier used by a target cell; frequency information and/or a cell identifier used by a cell in which a radio connection related failure occurs; frequency information and/or a cell identifier used by a reconnected cell; frequency information and/or a cell identifier used by a cell initiating an IMS voice fallback process; a result of measurement on a current serving cell and/or a neighboring cell by the UE; frequency information used for redirection; cell reselection priorities; measurement configuration information used by the UE in an RRC_IDLE or RRC_INACTIVE state; service interruption time, including at least one of the following: a difference between the time when the UE initiates an IMS voice service and the time when the access node transmits an IMS voice fallback indication to the UE, a difference between the time when the access node transmits an IMS voice fallback indication to the UE and the time when establishment of the IMS voice service is completed, and a difference between the time when the UE initiates an IMS voice service and the time when establishment of the IMS voice service is completed; and a report type, indicating a problem that occurs in an IMS voice related process, wherein the problems include at least one of the following: IMS voice fallback handover is too early, IMS voice fallback handover is handover to a wrong cell, IMS voice fallback redirection fails, IMS voice fallback redirection is redirection to a wrong cell, handover is successful, IMS voice fallback handover is successful, emergency fallback fails, a secondary cell is added too early due to an IMS voice service configuration process, or a wrong secondary cell is added due to an IMS voice service configuration process.

Optionally, the indication information also indicates that the IMS voice fallback process or IMS voice service configuration process or emergency fallback process is handover or redirection.

Optionally, the method further includes obtaining a report generated by the UE, and optimizing IMS voice fallback related parameters in response to obtaining the first information and the report.

Optionally, the report type is generated by the at least one other node.

Optionally, the first information is included in a report generated by the UE.

According to an aspect of the disclosure, there is provided a method performed by a second node in a wireless communication system, including: transmitting first information to a first node, which indicates that a problem occurs in or after an Internet Protocol (IP) Multimedia Subsystem (IMS) voice related process of a user equipment (UE), wherein the first node is an access node in the wireless communication system, and the second node is another access node or a core network node in the wireless communication system.

Optionally, the first information includes at least one of the following: indication information, indicating that a report generated by the UE is caused by an IMS voice fallback process or an IMS voice service configuration process or an emergency fallback process, or indicating that the first information is related to an IMS voice fallback process, or indicating that IMS voice fallback related information is set incorrectly; frequency information and/or a cell identifier used by a target cell; frequency information and/or a cell identifier used by a cell in which a radio connection related failure occurs; frequency information and/or a cell identifier used by a reconnected cell; frequency information and/or a cell identifier used by a cell initiating an IMS voice fallback process; a result of measurement on a current serving cell and/or a neighboring cell by the UE; frequency information used for redirection; cell reselection priorities; measurement configuration information used by the UE in an RRC_IDLE or RRC_INACTIVE state; service interruption time, including at least one of the following: a difference between the time when the UE initiates an IMS voice service and the time when the access node transmits an IMS voice fallback indication to the UE, a difference between the time when the access node transmits an IMS voice fallback indication to the UE and the time when establishment of the IMS voice service is completed, and a difference between the time when the UE initiates an IMS voice service and the time when establishment of the IMS voice service is completed; and a report type, indicating a problem that occurs in an IMS voice related process, wherein the problems include at least one of the following: IMS voice fallback handover is too early, IMS voice fallback handover is handover to a wrong cell, IMS voice fallback redirection fails, IMS voice fallback redirection is redirection to a wrong cell, handover is successful, IMS voice fallback handover is successful, emergency fallback fails, a secondary cell is added too early due to an IMS voice service configuration process, or a wrong secondary cell is added due to an IMS voice service configuration process.

Optionally, the indication information also indicates that the IMS voice fallback process or IMS voice service configuration process or emergency fallback process is handover or redirection.

Optionally, the first information is separated from the report generated by the UE, and the second node transmits the first information together with the report to the first node, in order for the first node to optimize IMS voice fallback related parameters.

Optionally, the method further includes generating the report type and updating the first information based on the generated report type.

Optionally, the first information is included in a report generated by the UE.

According to an aspect of the disclosure, there is provided a node in a wireless communication system, including: a transceiver configured to transmit and receive data; and a processor configured to control the transceiver to perform various methods of the disclosure.

Various embodiments of the disclosure may be implemented as computer-readable codes embodied on a computer-readable recording medium from a specific perspective. The computer-readable recording medium may be a volatile computer-readable recording medium or a nonvolatile computer-readable recording medium. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media can be distributed by computer systems connected via a network, and thus computer-readable codes can be stored and executed in a distributed manner. Furthermore, functional programs, codes and code segments for implementing various embodiments of the disclosure can be easily explained by those skilled in the art to which the embodiments of the disclosure are applied.

It will be understood that the embodiments of the disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program (s) with instructions for implementing embodiments of the disclosure. The disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the disclosure suitably includes its equivalents.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
generating a report; and
transmitting the report to an access node in the wireless communication system,
wherein the report is generated in or after an Internet Protocol (IP) Multimedia Subsystem (IMS) voice related process of the UE.

2. The method of claim 1, wherein the report includes first information, and the first information includes at least one of the following:
indication information, indicating that the report generated by the UE is caused by an IMS voice fallback process or an IMS voice service configuration process or an emergency fallback process, or indicating that the first information is related to an IMS voice fallback process, or indicating that IMS voice fallback related information is set incorrectly;
frequency information and/or a cell identifier used by a target cell;
frequency information and/or a cell identifier used by a cell in which a radio connection related failure occurs;
frequency information and/or a cell identifier used by a reconnected cell;
frequency information and/or a cell identifier used by a cell initiating an IMS voice fallback process;
a result of measurement on a current serving cell and/or a neighboring cell by the UE;
frequency information used for redirection;
cell reselection priorities;
measurement configuration information used by the UE in a radio resource control (RRC)_IDLE or RRC_INACTIVE state;
service interruption time, including at least one of the following:
a difference between a time when the UE initiates an IMS voice service and a time when the access node transmits an IMS voice fallback indication to the UE,
a difference between the time when the access node transmits the IMS voice fallback indication to the UE and a time when establishment of the IMS voice service is completed, or
a difference between the time when the UE initiates the IMS voice service and the time when establishment of the IMS voice service is completed; or
a report type, indicating a problem that occurs in an IMS voice fallback process or an IMS voice service configuration process or an emergency fallback process.

3. The method of claim 2, wherein the problem includes at least one of the following:
IMS voice fallback handover is too early, IMS voice fallback handover is handover to a wrong cell;
IMS voice fallback redirection fails, IMS voice fallback redirection is redirection to a wrong cell, handover is successful; or
IMS voice fallback handover is successful, emergency fallback fails, a secondary cell is added too early due to an IMS voice service configuration process, or a wrong secondary cell is added due to an IMS voice service configuration process.

4. The method of claim 2, wherein the indication information further indicates that the IMS voice fallback process or the emergency fallback process is handover or redirection.

5. A method performed by a first node in a wireless communication system, the method comprising:
obtaining first information from at least one other node in the wireless communication system, which indicates that a problem occurs in or after an Internet Protocol (IP) Multimedia Subsystem (IMS) voice related process of a user equipment (UE); and
optimizing IMS voice fallback related parameters in response to obtaining the first information,
wherein the first node is an access node, and the at least one other node is a UE or another access node or a core network node in the wireless communication system.

6. The method of claim 5, wherein the first information includes at least one of the following:
indication information, indicating that a report generated by the UE is caused by an IMS voice fallback process or an IMS voice service configuration process or an emergency fallback process, or indicating that the first information is related to an IMS voice fallback process or an IMS voice service configuration process or an emergency fallback process, or indicating that IMS voice fallback related information is set incorrectly;
frequency information and/or a cell identifier used by a target cell;
frequency information and/or a cell identifier used by a cell in which a radio connection related failure occurs;
frequency information and/or a cell identifier used by a reconnected cell;
frequency information and/or a cell identifier used by a cell initiating an IMS voice fallback process;
a result of measurement on a current serving cell and/or a neighboring cell by the UE;
frequency information used for redirection;
cell reselection priorities;
measurement configuration information used by the UE in a radio resource control (RRC)_IDLE or RRC_INACTIVE state;
service interruption time, including at least one of the following:
a difference between a time when the UE initiates an IMS voice service and a time when the access node transmits an IMS voice fallback indication to the UE,
a difference between the time when the access node transmits the IMS voice fallback indication to the UE and a time when establishment of the IMS voice service is completed, or
a difference between the time when the UE initiates the IMS voice service and the time when establishment of the IMS voice service is completed; or
a report type, indicating a problem that occurs in an IMS voice related process.

7. The method of claim 6, wherein the problem includes at least one of the following:
IMS voice fallback handover is too early, IMS voice fallback handover is handover to a wrong cell;
IMS voice fallback redirection fails, IMS voice fallback redirection is redirection to a wrong cell, handover is successful; or
IMS voice fallback handover is successful, emergency fallback fails, a secondary cell is added too early due to an IMS voice service configuration process, or a wrong secondary cell is added due to an IMS voice service configuration process.

8. The method of claim 6, wherein the indication information further indicates that the IMS voice fallback process or the emergency fallback process is handover or redirection.

9. The method of claim 5, further comprising:
obtaining a report generated by the UE; and
optimizing IMS voice fallback related parameters in response to obtaining the first information and the report.

10. The method of claim 5, wherein the first information is included in a report generated by the UE.

11. A method performed by a second node in a wireless communication system, the method comprising:
transmitting first information to a first node, which indicates that a problem occurs in or after an Internet Protocol (IP) Multimedia Subsystem (IMS) voice related process of a user equipment (UE),
wherein the first node is an access node in the wireless communication system, and the second node is another access node or a core network node in the wireless communication system.

12. The method of claim 11, wherein the first information includes at least one of the following:
indication information, indicating that a report generated by the UE is caused by an IMS voice fallback process or an IMS voice service configuration process or an emergency fallback process, or indicating that the first information is related to an IMS voice fallback process, or indicating that IMS voice fallback related information is set incorrectly;
frequency information and/or a cell identifier used by a target cell;
frequency information and/or a cell identifier used by a cell in which a radio connection related failure occurs;
frequency information and/or a cell identifier used by a reconnected cell;
frequency information and/or a cell identifier used by a cell initiating an IMS voice fallback process;
a result of measurement on a current serving cell and/or a neighboring cell by the UE;
frequency information used for redirection;
cell reselection priorities;
measurement configuration information used by the UE in a radio resource control (RRC)_IDLE or RRC_INACTIVE state;
service interruption time, including at least one of the following:
a difference between a time when the UE initiates an IMS voice service and a time when the access node transmits an IMS voice fallback indication to the UE,
a difference between the time when the access node transmits the IMS voice fallback indication to the UE and a time when establishment of the IMS voice service is completed, or
a difference between the time when the UE initiates the IMS voice service and the time when establishment of the IMS voice service is completed; or
a report type, indicating a problem that occurs in an IMS voice related process.

13. The method of claim 12, wherein the problem includes at least one of the following:
IMS voice fallback handover is too early, IMS voice fallback handover is handover to a wrong cell;
IMS voice fallback redirection fails, IMS voice fallback redirection is redirection to a wrong cell, handover is successful; or
IMS voice fallback handover is successful, emergency fallback fails, a secondary cell is added too early due to an IMS voice service configuration process, or a wrong secondary cell is added due to an IMS voice service configuration process.

14. The method of claim 12, wherein the indication information further indicates that the IMS voice fallback process or emergency fallback process is handover or redirection.

15. The method of claim 11, wherein the second node transmits the first information to the first node together with a report generated by the UE, in order for the first node to optimize IMS voice fallback related parameters.

16. The method of claim 15, further comprising:
generating a report type, and updating the first information based on the generated report type.

17. The method of claim 11, wherein the first information is included in a report generated by the UE.

18. A user equipment (UE) in a wireless communication system, the UE comprising:
a transceiver; and
a processor coupled with the transceiver and configured to:
generate a report; and
transmit the report to an access node in the wireless communication system,
wherein the report is generated in or after an Internet Protocol (IP) Multimedia Subsystem (IMS) voice related process of the UE.

19. A first node in a wireless communication system, the first node comprising:
a transceiver; and
a processor coupled with the transceiver and configured to:
obtain first information from at least one other node in the wireless communication system, which indicates that a problem occurs in or after an Internet Protocol (IP) Multimedia Subsystem (IMS) voice related process of a user equipment (UE), and
optimize IMS voice fallback related parameters in response to obtaining the first information,
wherein the first node is an access node, and the at least one other node is a UE or another access node or a core network node in the wireless communication system.

20. A second node in a wireless communication system, the second node comprising:
a transceiver; and
a processor coupled with the transceiver and configured to:
transmit first information to a first node, which indicates that a problem occurs in or after an Internet Protocol (IP) Multimedia Subsystem (IMS) voice related process of a user equipment (UE),
wherein the first node is an access node in the wireless communication system, and the second node is another access node or a core network node in the wireless communication system.
